(19) United States
(12) Patent Application Publication
(10) Pub. No.: US 2022/0036194 A1
(43) Pub. Date: Feb. 3, 2022

(54) DEEP NEURAL NETWORK OPTIMIZATION SYSTEM FOR MACHINE LEARNING MODEL SCALING

(71) Applicant: Intel Corporation, Santa Clara, CA (US)

(72) Inventors: Sairam Sundaresan, San Diego, CA (US); Souvik Kundu, Los Angeles, CA (US)

(21) Appl. No.: 17/504,282

(22) Filed: Oct. 18, 2021

(51) Int. Cl. G06N 3/08; G06N 3/04

(52) U.S. Cl. CPC G06N 3/082; G06N 3/04

(57) ABSTRACT

The present disclosure is related to techniques for optimizing artificial intelligence (AI) and/or machine learning (ML) models to reduce resource consumption while maintaining or improving AI/ML model performance. A sparse distillation framework (SDF) is provided for producing a class of parameter and compute efficient AI/ML models suitable for resource constrained applications. The SDF simultaneously distills knowledge from a compute heavy teacher model while also pruning a student model in a single pass of training, thereby reducing training and tuning times considerably. A self-attention mechanism may also replace CNNs or convolutional layers of a CNN to have better translational equivariance. Other embodiments may be described and/or claimed.

### TECHNICAL FIELD

Embodiments described herein generally relate to artificial intelligence (AI), machine learning (ML), and Neural Architecture Search (NAS) technologies, and in particular, to techniques for Deep Neural Network (DNN) model engineering and optimization.

### BACKGROUND

Machine learning (ML) is the study of computer algorithms that improve automatically through experience and by the use of data. Performing machine learning involves creating a statistical model (or simply a “model”), which is configured to process data to make predictions and/or inferences. ML algorithms build models using sample data (referred to as “training data”) and/or based on past experience in order to make predictions or decisions without being explicitly programmed to do so.

ML model design is a lengthy process that involves a highly iterative cycle of training and validation to tune the structure, parameters, and/or hyperparameters of a given ML model. The training and validation can be especially time consuming and resource intensive for larger ML architectures such as deep neural networks (DNNs) and the like. Conventional ML design techniques may also require relatively large amounts of computational resources beyond the reach of many users.

The efficiency of an ML model, in terms of resource consumption, speed, accuracy, and other performance metrics, are based in part on the number and type of parameters used for the ML model. The parameters used for the ML model include “model parameters” (also referred to simply as “parameters”) and “hyperparameters.” Model parameters are parameters derived via training, whereas hyperparameters are parameters whose values are used to control aspects of the learning process and usually have to be set before running an ML model. Changes to model parameters and/or hyperparameters can greatly impact the performance of a given ML model. In particular, reducing the number of parameters may decrease the performance of a model, but may allow the model to run faster and use less memory than it would with a larger number of parameters.

For example, existing computer vision models rely heavily on convolution-based architectures (e.g., convolutional neural networks (CNNs)), which scale poorly with receptive field sizes, apply the same set of weights to all parts of the input, and have a significant increase in parameters and floating point operations (FLOPs) as the model size grows. This can lead to increased training, optimization and inference times, particularly in the context of applications such as Neural Architecture Search (NAS), federated learning, and the like.

Current approaches to improve ML model efficiency include using knowledge distillation or pruning in isolation to reduce the computation and/or storage budget required for the model for inference deployment. These approaches are discussed in Gou et al., “Knowledge distillation: A survey”, Int'l J. of Comp. Vision, vol. 129, no. 6, pp. 1789-819 (2021) (“[Gou]”) and Cheng et al., “A Survey of Model Compression and Acceleration for Deep Neural Networks”, IEEE Signal Processing Mag., Special Issue on Deep Learning for Image Understanding, arXiv:1710.09282v9 (14 Jun. 2020) (“[Cheng]”). However, these current approaches involve highly iterative training processes, which increases the training time and resource usage overhead. These drawbacks are also exacerbated by the need for significant parameter tuning, and therefore, these approaches are not easily scalable. Even after such lengthy fine-tuning processes, the current approaches do not guarantee a reasonable compromise between ML model accuracy, model size, speed, and power.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows an overview of a joint optimization framework according to various embodiments.

FIGS. 2, 3, 4, and 5 depict an overview of a sparse distillation system according to various embodiments.

FIG. 6 depicts a sparse distillation process according to various embodiments.

FIG. 7 depicts an example NAS architecture including the sparse distillation system of FIGS. 2, 4, 3, and 5 according to various embodiments.

FIG. 8 depicts an example NAS procedure according to various embodiments.

FIG. 9 depicts an example artificial neural network (ANN).

FIG. 10a illustrates an example accelerator architecture.

FIG. 10b illustrates an example components of a computing system.

FIG. 11 depicts an example procedure that may be used to practice the various embodiments discussed herein.

### DETAILED DESCRIPTION

The present disclosure is related to techniques for optimizing artificial intelligence (AI) and/or machine learning (ML) models to reduce resource consumption while improving AI/ML model performance. In particular, the present disclosure provides a framework for producing a class of parameter and compute efficient ML models suitable for resource constrained applications. This framework is referred to herein as “sparse distillation”.

The sparse distillation framework discussed herein sparsely distills a relatively large reference ML model (referred to herein as a “supernetwork” or “supernet”) into a smaller ML model (referred to herein as a “subnetwork” or “subnet”). As an example, a supernet may be a relatively large and/or dense ML model that an end-user has developed, but is expensive to operate in terms of computation, storage, and/or power consumption. This supernet may include parameters and/or weights that do not significantly contribute to the prediction and/or inference determination, and these parameters and/or weights contribute to the supernet's overall computational complexity and density. Therefore, the supernet contains a smaller subnet that, when trained in isolation, can match the accuracy (or other performance metrics) of the original ML model (supernet). Additionally, it may be possible for the subnet to outperform the supernet in certain scenarios.

The sparse distillation framework fuses knowledge distillation (KD) and pruning. The KD mechanism transfers knowledge from the supernet (teacher model) to the subnet (student model) while the pruning mechanism prunes unnecessary parameters or weights from the subnet. Here, the subnet is a desired output model that meets the end users' requirements and/or has a smaller footprint than the supernet (e.g., consumes less computation, storage and/or power resources than the supernet from which it is generated). In some implementations, such as those involving convolution neural networks (CNNs), the sparse distillation framework further fuses self-attention (SA) with KD and pruning. In these implementations, SA mechanisms may replace or may act as a substitute for convolutions in a CNN. The SA mechanisms, given an input sequence of items, estimate the relevance of individual items to other items in that sequence.

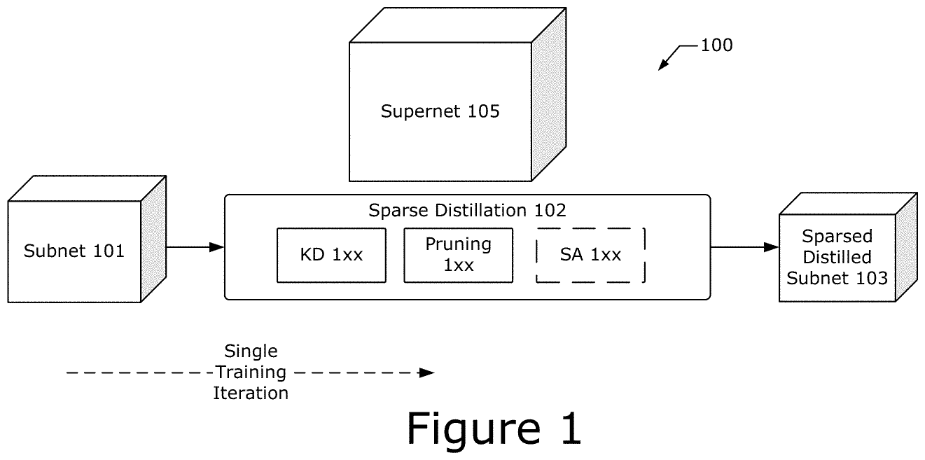

Sparse distillation simultaneously distills knowledge from a compute heavy teacher model (e.g., teacher model 110 of FIG. 1) while also pruning a student model (e.g., student model 101 of FIG. 1) in a single pass of training (e.g., a single iteration of a training process), thereby considerably reducing training and tuning time and resources in comparison to existing optimization techniques. Not only do models going through the sparse distillation framework significantly outperform unoptimized counterparts in accuracy, in some cases, these models perform almost as well as their compute-heavy teachers while consuming only a fraction of the parameters and FLOPs. Concretely, in some simulations, sparse distilled models achieved up to 30× parameter efficiency and 2× computation efficiency with no significant accuracy drop compared to their teacher model.

In disclosed embodiments, a sparse distillation system obtains inputs including a parameter budget, hardware device/platform configuration information, and a reference ML model (supernet). The sparse distillation system uses this information to simultaneously distill the supernet into a subnet while pruning the subnet. Additionally, the sparse distillation system may replace any convolutions in the supernet or subnet with SA mechanisms (see e.g., Khan et. al, “Transformers in Vision, A Survey” arXiv:2101.01169v2 [cs.CV] 22 Feb. 2021 (“[Khan]”), which is hereby incorporated by reference in its entirety) to have better translational equivariance, if needed.

The sparse distillation system discussed herein is the first ML model optimization approach that simultaneously distills, prunes, and optimizes subnets in a hardware-aware manner, which significantly reduces the resource consumption and the amount of time required for training and optimizing an ML model while providing an ML model that does not compromise on performance in terms of accuracy, speed, and power. Furthermore, the sparse distillation system can be implemented in a plug-and-play manner, such that it can be plugged into a number of other applications such as, for example, neural architecture search, federated learning, Internet of Things (IoT) applications, and the like. This is because the sparse distillation system does not change existing training methods while producing better results compared to any existing ML training frameworks.

The sparse distillation aspects are discussed infra in the context of convolutional neural networks (CNNs) for image classification in the computer vision domain, as examples. However, other tasks such as object detection, image segmentation, and captioning could also benefit from the sparse distillation embodiments discussed herein. Furthermore, the sparse distillation embodiments discussed herein can be straightforwardly applied to other AI/ML domains, architectures, and/or topologies such as, for example, recommendation systems, acoustic modeling, natural language processing (NLP), graph NNs, recurrent NNs (RNNs), Long Short Term Memory (LSTM) networks, transformer models/architectures, and/or any other AI/ML domain or task such as those discussed elsewhere in the present disclosure.

### 1. Sparse Distillation System and Framework

FIG. 1 shows an overview of a joint optimization framework 100 that uses sparse distillation according to various embodiments. The joint optimization framework 100 is based on a joint optimization strategy where a sparse distillation layer 102 extracts positional context and knowledge data from a supernet 105, and a pruning mechanism limits the parameter budget of the subnet 101 to produce a sparse distilled subnet 103.

The joint optimization framework 100 may be used to optimize CNNs, which have been the backbone for several computer vision tasks including image recognition, object detection and image segmentation. However, existing CNNs are content agnostic in nature, as the same weights are applied at all locations of an input feature map. While being content agnostic has the effect of somewhat reducing parameters, it also reduces the overall accuracy of the ML model. Furthermore, the parameter increase due to an increase in the receptive field size of convolutional layers outweighs any gains obtained by weight sharing. Thus, both parameter count and floating-point operations (FLOPs) scale poorly with an increase in receptive field, which is essential to capture long range interaction of pixels.

As mentioned previously, existing approaches to mitigate the limitations of CNNs include KD and pruning methods. KD involves a two-stage training process where a teacher model teaches a simpler student model through the transference of logits or features (see e.g., Hinton et al., “Distilling the Knowledge in a Neural Network”, arXiv preprint arXiv:1503.02531 (9 Mar. 2015) (“[Hinton]”), Zagoruyko et al., “Paying More Attention to Attention: Improving the Performance of Convolutional Neural Networks via Attention Transfer”, arXiv preprint arXiv:1612.03928 (12 Dec. 2016) (“[Zagoruyko]”), Tian et al., “Contrastive Representation Distillation”, arXiv:1910.10699v2 [cs.LG] (18 Jan. 2020), and [Gou], the contents of each of which are hereby incorporated by reference in their entireties). The teacher model is much larger than the student model (in terms of parameter space size), and therefore, is more compute intensive than the student model. However, the teacher model provides more accurate predictions than the student model. A first stage of the training process involves training the teacher model on a particular task using a set of training data (or examples) before distillation takes place. A second stage of the training process includes a distillation approach where the teacher model teaches the student model. In particular, the teacher model is used to extract knowledge, which are then used to guide the training of the student model during distillation. In these ways, KD is an iterative, repetitive process that requires tweaking various parameters to make sure that the student is learning properly from the teacher.

Pruning involves iteratively removing unnecessary weights and/or parameters that do not significantly affect the accuracy of a given model, which in effect makes the model smaller (see e.g., Zhang et al., “A Systematic DNN Weight Pruning Framework using Alternating Direction Method of Multipliers”, Proceedings of the European Conference on Computer Vision (ECCV), pp. 184-199 (2018). (“[Zhang]”), Dettmers et al., “Sparse Networks from Scratch: Faster Training Without Losing Performance”, arXiv:1907.04840v2 [cs.LG] (23 Aug. 2019) (“[Dettmers]”), Mostafa et al., “Parameter Efficient Training of Deep Convolutional Neural Networks by Dynamic Sparse Reparameterization”, International Conference on Machine Learning, PMLR, pp. 4646-4655 (24 May 2019) (“[Mostafa]”), and Lee et al., “SNIP: Single-Shot Network Pruning Based on Connection Sensitivity”, arXiv:1810.02340v2 (23 Feb. 2019), the contents of each of which are hereby incorporated by reference in their entireties). Pruning also requires retraining the model each time a parameter is removed to determine whether removal of the parameter significantly damages the model's performance. The iterative removal and training of the model takes place until a set of weights is discovered that does not significantly reduce the model's performance. In this way, pruning methods are also time consuming and resource intensive.

In the joint optimization framework 100, the supernet 105 plays the role of the teacher model (e.g., a convolutional teacher model) and the subnet 101 plays the role of the student model in the KD method. In embodiments, pruning and KD takes place simultaneously. This means that the joint optimization framework 100 simultaneously prunes the subnet 101 while distilling knowledge from the supernet 105 into it to produce the subnet 103. In addition, the joint optimization framework 100 may use both KD hyperparameters and pruning hyperparameters (referred to as “joint hyperparameters”) to simultaneously distill knowledge and prune the supernet 105 to produce the subnet 103. Here, distilling knowledge from the supernet 105 into the subnet 103 means that the subnet 101 learns how to perform a desired task from the supernet 105. In some implementations, the pruning process includes randomly removing weights/parameters from the subnet 101. In other implementations, the pruning process includes taking the momentum or the gradient of information of the weights and/or other parameters, and retaining a set of weights/parameters that have larger gradient values than other weights/parameters. The set of retained weights/parameters can be a predetermined or configured number of weights/parameters that have the largest momentums/gradients, or the set of retained weights/parameters can be weights/parameters having momentums/gradients at or above a threshold value. In these implementations, the weights/parameters having larger gradient values are assumed to be more impactful on the final ML model (e.g., a loss function of the final ML model).

In addition to performing the KD and pruning simultaneously, the framework 100 may also include a self-attention (SA) mechanism. In some implementations the framework 100 replaces convolutions (e.g., convolutional layers in a CNN) with self-attention (SA) mechanisms. In some implementations, the SA mechanism can be a standalone SA implementation (e.g., built independently of an existing CNN). Additionally or alternatively, the SA mechanism can be built from an already existing CNN, where the convolutional layers in the CNN are replaced with self-attention layers and the other layers in the original CNN (e.g., activation layers, pooling layers, dense layers, etc.) remain in place. Although the present disclosure discusses some examples of the sparse distillation framework as including an SA mechanism, the embodiments herein may work on any type of ML model including, but not limited to SA models as student and/or teacher models. In various embodiments, the teacher and/or student models may be any type of ML models (or combinations of ML models) such as those discussed herein.

Attention mechanisms include ML techniques that mimic cognitive attention by emphasizing important parts of input data and deemphasizing less important parts of the input data. Attention mechanisms involve queries, values, and keys, where queries mimic volitional cues in cognitive attention, values (e.g., intermediate feature representations) mimic sensory inputs in cognitive attention, and keys mimic non-volitional cue of the sensory input in cognitive attention. Attention mechanisms map queries and sets of key-value pairs to corresponding outputs, where the query, keys, values, and output are all vectors; the output is computed as a weighted sum of the values, where the weight assigned to each value is computed by a compatibility function of the query with the corresponding key (see e.g., Vaswani et al., “Attention Is All You Need”, Advances in Neural Information Processing Systems 30 (NIPS 2017), pp. 5998-6008 (2017) (“[Vaswani]”), the contents of which are hereby incorporated by reference in its entirety). In other words, each query attends to all the key-value pairs and generates one attention output.

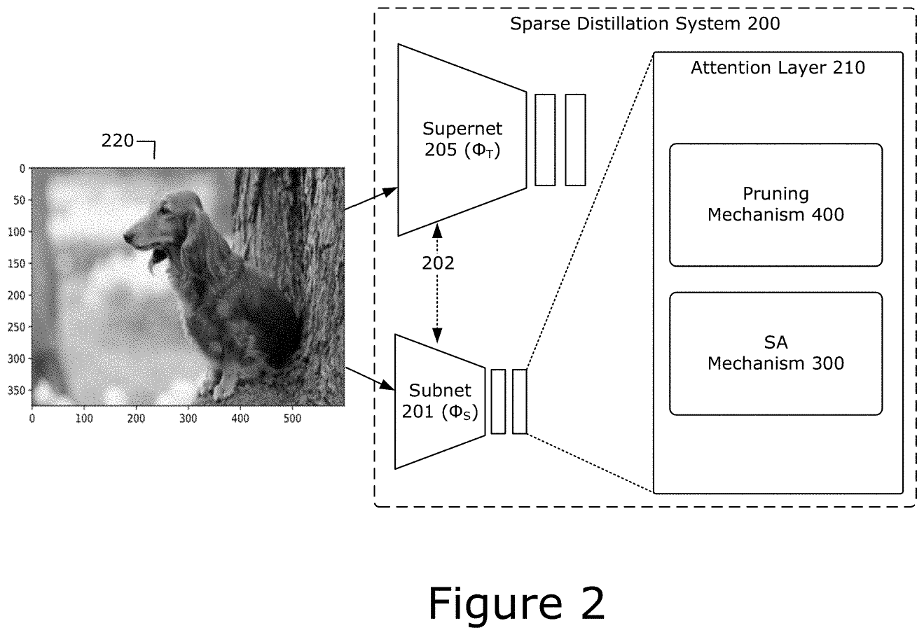

SA involves producing a weighted average of values computed from hidden units, where the weights used in the weighted average operation are produced dynamically via a similarity function between hidden units. As a result, the interaction between input signals depends on the signals themselves rather than being predetermined by their relative location, as is the case in convolutions. In particular, this allows SA to capture ‘long range’ interactions without increasing the number of parameters. In embodiments, the SA mechanism (e.g., SA mechanism 300 of FIGS. 2-5) captures long-term (or long range) information and dependencies between sequence elements. Given a sequence of elements, the SA mechanism estimates the relevance of one element to other elements in the sequence. The SA mechanism updates each component of the sequence by aggregating global information from the complete input sequence. The SA mechanism does this by encoding each entity/item in terms of a global context. This is done by defining three learnable weight matrices to transform, including a queries matrix W_{Q}, a keys matrix W_{K}, and a values matrix W_{V}. The input sequence is first projected onto these weight matrices (e.g., by multiplying the input sequence by each weight matrix), and the output of the SA mechanism 300 computes the dot-product of the query with all keys, which is then normalized using softmax operator to obtain the attention scores. Each entity then becomes the weighted sum of all entities in the sequence, where weights are given by the attention scores (also referred to herein as “attention weights”).

SA mechanisms have been used either alongside convolutions (see e.g., Bello et al., “Attention Augmented Convolutional Networks,” Proceedings of the IEEE/Computer Vision Foundation (CVF) Int'l Conference on Computer Vision, pp. 3286-3295 (2019) (“[Bello]”), the contents of which are hereby incorporated by reference in its entirety) or have completely replaced them in vision models (see e.g., Ramachandran et al., “Stand-Alone Self-Attention in Vision Models”, arXiv preprint arXiv:1906.05909 (13 Jun. 2019) (“[Rama]”), the contents of which are hereby incorporated by reference in its entirety), showing promising results for complex computer vision tasks. While SA mechanisms lack spatial context, positional embeddings can be used to make up for this limitation. SA mechanisms, unlike convolutions, consume fewer parameters and FLOPs, and scale much better with larger receptive fields enabling efficient capture of long range context without significantly increasing model complexity. SA mechanisms are also parallelizable and have the potential to be accelerated in suitable hardware by exploiting parallel execution (see e.g., Park et al., “OPTIMUS: OPTImized matrix MUltiplication Structure for Transformer neural network accelerator”, Proceedings of Machine Learning and Systems, vol. 2, pp. 363-78 (15 Mar. 2020) (“[Park]”), the contents of which are hereby incorporated by reference in its entirety).

The joint optimization training framework 100 takes advantage of all three mechanisms to create efficient ML models while also reducing the time it takes to optimize and fine tune such models. By combining the KD, pruning, and SA mechanisms in the manner discussed herein, the ML model scales better than ML models that use existing training and optimization methods, and the ML model becomes content aware. Additionally, in contrast to the existing pruning and KD methods, the joint optimization training framework 100 only uses a single training stage by jointly performing the optimization and training.

FIGS. 2, 4, 3, and 5 show an example sparse distillation system 200 according to various embodiments. The sparse distillation system 200 may correspond to the sparse distillation layer 102 in the joint optimization training framework 100

The sparse distillation system 200 exploits the benefits from pruning, KD, and SA mechanisms. Using a compute-heavy and relatively large supernet 205 with rich positional information as a teacher model Φ_{T}, the supernet 205 distills knowledge into the subnet 201, which is an SA-based student model Φ_{S}. Simultaneously, sparse learning of the student model Φ_{S} is enforced to yield a pruned SA model that further reduces the model parameters and/or hyperparameters (see e.g., [Dettmers], [Mostafa], and Kundu et al., “A Tunable Robust Pruning Framework Through Dynamic Network Rewiring of DNNs”, arXiv:2011.03083v2 [cs.CV] (24 Nov. 2020) (“[Kundu]”), the contents of which are hereby incorporated by reference in its entirety). The sparse distillation system 200 supports both structured column/channel pruning and magnitude pruning to yield models that can increase inference speeds as well offer the benefit of reduced parameters across various target hardware without requiring any custom designs or packages. Unlike many existing pruning schemes (such as those discussed in [Zhang]), sparse distillation requires only a global target parameter density and only one pass of training, significantly reducing memory access and the computation burden associated with iterative optimization techniques. Additionally or alternatively, the sparse distillation system 200 is extended to support structured column pruning to yield models that can increase inference speeds as well offer the benefit of reduced parameters. In the example of FIGS. 2, 4, 3, and 5, the sparse distillation system 200 is shown performing a computer vision task, however, other ML tasks can be performed using the sparse distillation system 200.

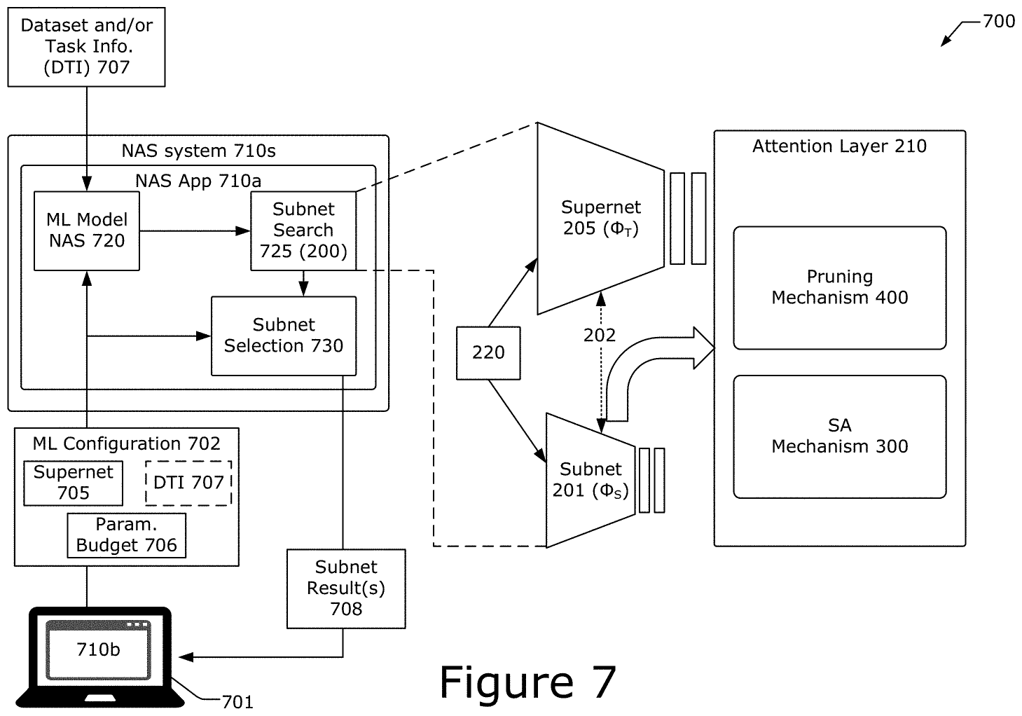

Prior to operation of the sparse distillation system 200 (e.g., during a setup or training configuration using the sparse distillation system 200), an ML model designer, developer or other user (e.g., a user of client device 701 of FIG. 7) provides the sparse distillation system 200 with an ML configuration (e.g., ML config. 702 of FIG. 7) that at least includes or indicates the supernet 205 (and/or its associated parameters, hypermarameters, and other information/data) and a parameter budget (e.g., parameter budget 706 of FIG. 7). The parameter budget 706 (also referred to as a “subnet definition 706”, “parameter configuration 706”, and/or the like) is a file or other data structure that defines the desired parameters for the subnet 201 after the training session is completed. For example, the parameter budget 706 may specify that the subnet 201 should not have more than a certain number of parameters, a number of a specific type of parameters, and/or other aspects that the subnet 201 should have. The sparse distillation system 200 uses this information to perform the joint optimization and training.

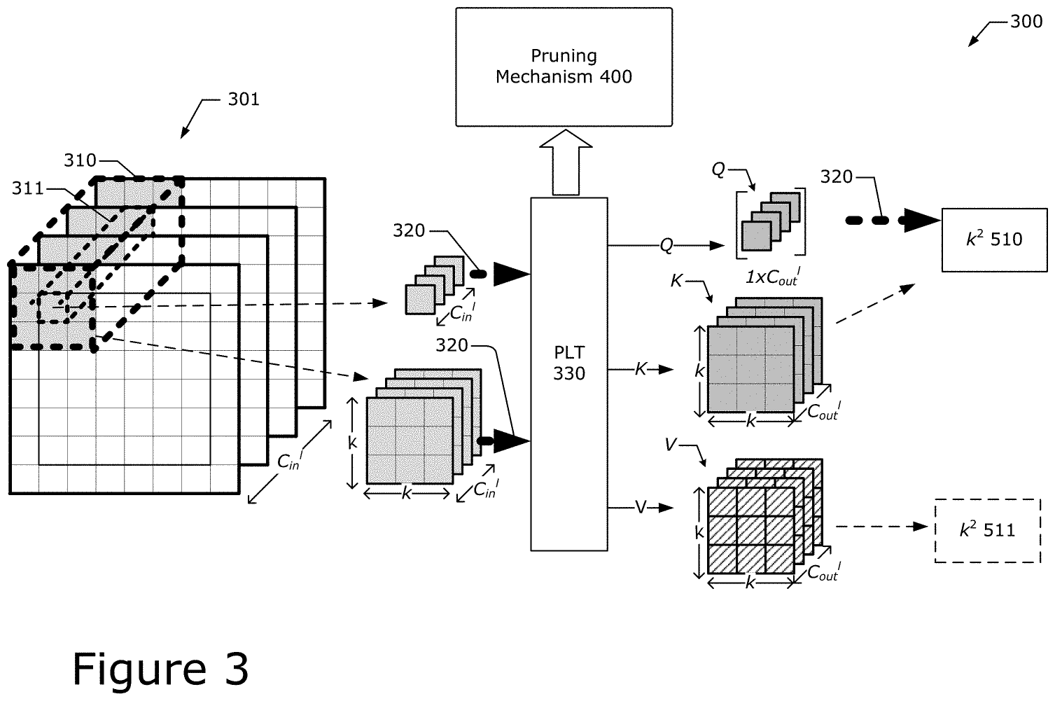

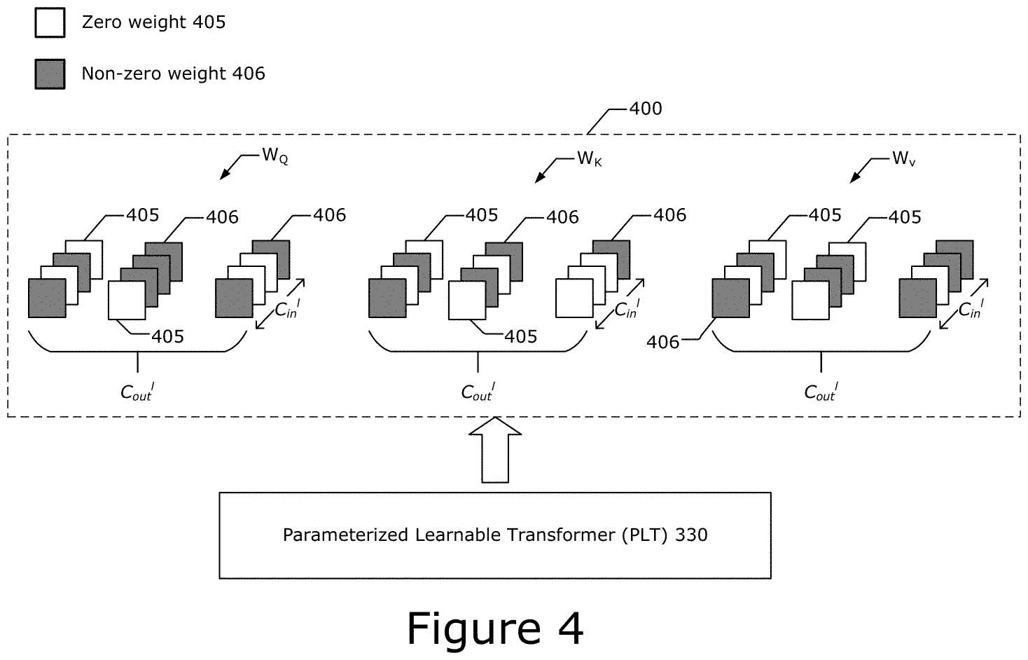

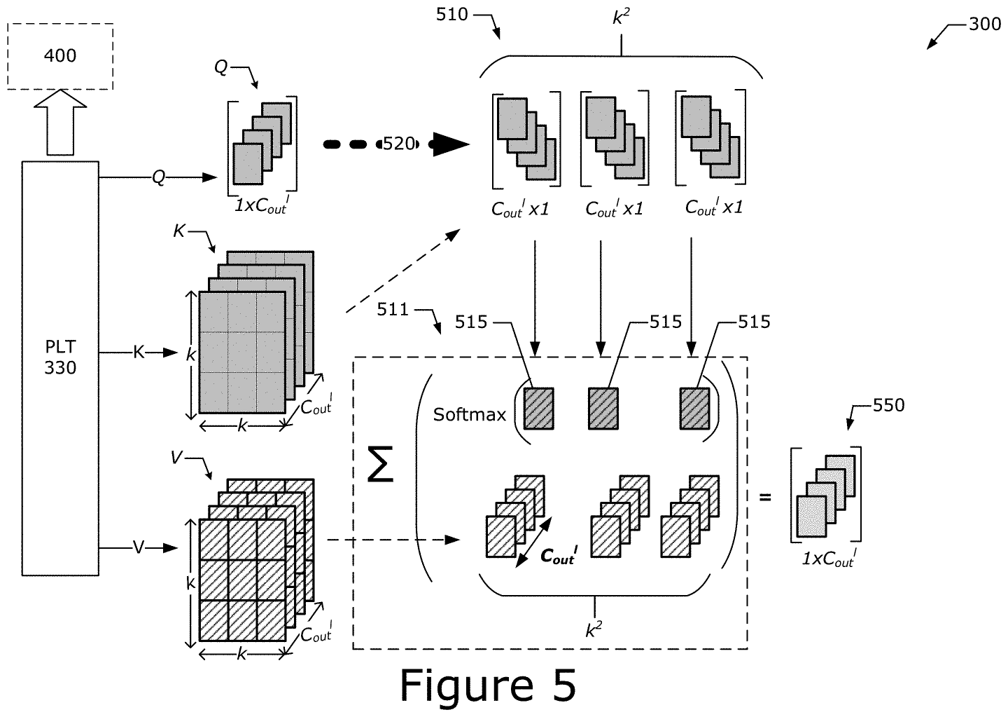

Referring to FIG. 2, an input image 220 (e.g., a still picture or a video frame) is fed to both the supernet 205 (also referred to herein as “teacher 205” or “Φ_{T}”) and the subnet 201 (also referred to herein as “student 201” or “Φ_{S}”) of the sparse distillation system 200. The supernet 205 may be the same or similar to the supernet 105 of FIG. 1, and the subnet 201 may be the same or similar to the subnet 101 of FIG. 1. During distillation 202, an output of the supernet 205 is used to train the subnet 201. This is discussed in more detail infra in section 1.1. FIG. 2 also shows an attention layer 210 that is part of the subnet 201. The attention layer 210 may be included as part of the subnet 201, or the subnet 201 may be communicatively coupled with the attention layer 210. The attention layer 210 includes a pruning mechanism 400 and an SA mechanism 300. FIGS. 4, 3, and 5 show the internal attention layer 210 computation mechanics of the student model Φ_{S}. In particular, FIG. 4 shows the mechanics of the pruning mechanism 400 (discussed infra in section 1.3) and FIGS. 3 and 5 show the mechanics of the SA mechanism 300 (discussed infra in section 1.2).

1.1. Knowledge Distillation (KD) Mechanism

In embodiments, knowledge is distilled from both logits and feature maps to improve the performance of the student model Φ_{S}. The logits may be one or more sets of raw or non-normalized probabilities or predictions, and a softmax function may be used to convert logits into probabilities. In some implementations, a softmax temperature based KD method can be used to transfer knowledge from logits (see e.g., [Hinton]). Here, temperature is a hyperparameter used to control the randomness and/or softness of predictions by scaling the logits before applying the softmax function. Additionally, attention transfer is employed to transfer knowledge from the teacher's Φ_{T} activation maps (see e.g., [Zagoruyko]). The attention transfer distillation algorithm may be activation-based attention transfer or gradient-based attention transfer. The attention transfer enables the student Φ_{S} to learn both spatial context as well as the distribution of class probabilities while being pruned during training.

Furthermore, in some implementations, the knowledge extracted from the teacher Φ_{T} may be stored in a suitable storage system/device (e.g., a cache or caching system) before being distilled into the student Φ_{S}.

1.2. Self-Attention (SA) Mechanism

FIG. 3 shows a first part of the mechanics of the SA mechanism 300 where a sparse weight tensor 301 is obtained from the input 220. The sparse weight tensor 301 includes one or more layers l and a number of channels (or number of channels per filter) Cᵢₙ^{l}. Note that all k×k (k>1) convolutions have been replaced with SA layers in this example. A neighborhood 310 of k×k×Cᵢₙ^{l} pixels is extracted from the input 220 (where k is a kernel size), and a pixel 311 within the neighborhood 310 is also extracted from the input 220. The neighborhood 310 may also be referred to as a “local region 310” or a “feature map 310”, and may have an associated width W and height H (not shown by FIG. 3) in addition to the kernel size k. The neighborhood 310 has a spatial extent of size k centered around a pixel 311. The neighborhood 310 and pixel 311 are transformed into three content aware matrices including a queries matrix Q, a keys matrix K, and a values matrices V (which may be abbreviated herein as “Q-K-V matrices”). This transformation takes place through a Parameterized Learnable Transformation (PLT) 330. The PLT 330 may be a feature extractor or some other element/function that transforms training data (e.g., sparse weight tensor 301, local region 310, and/or pixel 311) into a set of weights or parameters (e.g., weights 405, 406 and/or weight matrices W_{Q}, W_{K}, and W_{V} in FIG. 4). In particular, the PLT 330 analyzes the input data (e.g., local region 310 and pixel 311) and learns a basis to produce the weights/parameters. Additionally or alternatively, the PLT 330 implements parameterized learning to learn, using the input data and training labels, a function (transform) that maps the input data to output predictions by defining a set of parameters and optimizing over that set of parameters. Additionally or alternatively, the PLT 330 learns an intermediate representation (namely, Q, K, V), which are then used to learn output feature maps. In some implementations, the PLT 330 may include a transformer architecture, such as those discussed in [Vaswani] and/or [Khan]. The PLT 330 may include respective operations 320 that transforms input data and/or the input feature map (IFM) into the weights/parameters. Here, each operation 320 may be a matrix multiplication operation and/or a 1×1 convolution operation.

The PLT 330 computes attention weights (e.g., weights 405, 406 and/or weight matrices W_{Q}, W_{K}, and W_{V} in FIG. 4) that are provided to the pruning mechanism 400, which is shown by FIG. 4. Here, the weights are not learned directly, as is the case with conventional CNNs. Instead, a transformation (e.g., PLT 330) is learned between the given input region 310 and the Q-K-V matrices to generate the corresponding weights 405, 406 (and/or corresponding weight matrices W_{Q}, W_{K}, and W_{V}). The Q-K-V matrices (and/or the weight matrices W_{Q}, W_{K}, and W_{V}) are generated on the fly based on the PLT 330. In these ways, the weights that are generated through the PLT 330 are specific to the region of interest 310 of the input 220.

Referring to FIG. 5, which shows a second part of the SA mechanism 300, the queries, keys, and values in the Q-K-V matrices, respectively (and/or weight matrices W_{Q}, W_{K}, and W_{V}), are transformations of the input region 310 and the neighborhood 310. The SA mechanism 300 computes a dot product between the queries matrix Q and the keys matrix K to produce a set of output channel Cₒᵤₜ^{l} vectors 510. This may involve an operation 520 (e.g., a matrix multiplication operation and/or a 1×1 convolution operation) being performed on the queries matrix Q. Element multiplication for scaling is performed on the output channel Cₒᵤₜ^{l} vectors 510 to produce elements 515, a softmax function is applied to the elements 515, and then summed with components of the values matrices V to produce an SA output channel Cₒᵤₜ^{l} 550. The SA output channel Cₒᵤₜ^{l} 550 is a feature map or vector, matrix, or tensor that is part of sparse distillation generated features maps that gets generated after every layer operation.

Continuing to refer to FIGS. 3 and 5, given an input feature map 310 at layer/of a network, a pixel at position (i,j), xᵢⱼ∈ [symbol] ^{C}^{ᵢₙ}^{^{l}} is considered. A convolution operation centered at this pixel operates in a k×k neighborhood [symbol] (i,j) (e.g., neighborhood 310 in FIG. 3) where k is the kernel size. A single-headed local SA layer replacing this convolution, with a spatial extent k considers all pixels from the neighboring locations (a, b)∈ [symbol] (i,j) and computes the output yᵢⱼ∈ [symbol] ^{C}^{ᵢₙ}^{^{l}} in as shown by equation (1).

$${y}_{i j} = {\sum }_{a , b ∈ {𝒩}_{k} ( i , j )} {softmax}_{a b} ( \frac{{q}_{i j}^{⊤} {k}_{a b}}{\sqrt{{C}_{o u t}^{l}}} + \frac{{q}_{i {j}^{r} a - i , b - i}^{⊤}}{\sqrt[4]{{C}_{o u t}^{l}}} ) {υ}_{a b} \qquad ( 1 )$$

In equation (1), qᵢⱼ=W_{Q}xᵢⱼ, k_{ab}=W_{K}x_{ab}, and ν_{ab}=W_{V}x_{ab} are the queries, keys, and values, respectively for pixel location (i, j). The superscript tee symbol (T) in qᵢⱼ^{T} indicates a transpose of qᵢⱼ (i.e., flipping the matrix over its diagonal to switch the row and column indices). The term r_{a-i,b-i} represents a simple relative positional embedding based on the offset (a−i, b−j), and helps learn the spatial context. The major trainable parameters here are W_{Q}, W_{K}, W_{V}∈ [symbol] ^{C}^{ᵢₙ}^{^{l}}^{×C}^{ₒᵤₜ}^{^{l}}, and they do not increase with an increase in spatial extent k. r_{a-i,b-i} is also a trainable parameter. In implementations, multi-headed SA is used, wherein N attention heads are each allowed to attend to

$$\frac{{C}_{o u t}^{l}}{N}$$

output channels. Following this, the results of all the heads are concatenated to produce yᵢⱼ∈ [symbol] ^{C}^{ᵢₙ}^{^{l}}.

In some implementations, an SA residual learning network (ResNet) architecture, such as SA ResNet26 and SA ResNet38 (see e.g., [Rama]), is used as the student model(s) Additionally or alternatively, two variants of each SA ResNet model may be used including hybrid SA ResNet models and homogeneous SA ResNet models. Any other ResNet may be used in other implementations. The hybrid SA ResNet models use a convolutional block at the first layer of the architecture (also called the model's stem) and the SA 300 replaces the remaining spatial-convolutions in the model. The homogeneous SA ResNet models use SA layers 300 throughout the model including the stem. In some implementations, the same simple relative positional embedding as in equation (1) is uniformly used to promote consistency and ease of parallelism in hardware (whereas [Rama] used a more sophisticated positional embedding while computing SA at the stem to compensate for the limited spatial awareness mentioned previously). In alternative implementations, a CNN could be used instead of the SA mechanism 300.

1.3. Pruning Mechanism

Referring to FIG. 4, the pruning mechanism 400 includes a query weight matrix W_{Q}, a keys weight matrix W_{K}, and a values weight matrix W_{B}. Each matrix W includes a set of zero weights (ZWs) 405 (i.e., weights with a value of “0”) and a set of non-zero weights (NZWs) 406 (i.e., weights with a value other than “0”). Note that not all ZWs 405 and NZWs 406 are labeled in FIG. 4 for the sake of clarity.

Pruning achieves inference parameter reduction by removing unimportant weights 405, from a model, while retaining the important weights 406. Pruning can be broadly classified into two categories including irregular pruning and structured pruning. Irregular pruning prunes weight scalars based on their importance and enjoys the advantage of lower parameter density (d) with similar accuracy as an unpruned model. The same cannot always be said for structured pruning that prunes at the granularity of filters, channels, or columns. However, irregularly pruned models suffer from the overhead of NZW 406 indices and often requires dedicated hardware to extract compression and speedup benefits (see e.g., [Kundu]). Despite the larger parameter density requirement, structured pruning can yield inference speedup without dedicated hardware support (see e.g., Liu et al., “Rethinking the Value of Network Pruning”, arXiv preprint arXiv:1810.05270 arXiv:1810.05270v2 [cs.LG] (5 Mar. 2019) (“[Liu]”)). The sparse distillation framework discussed herein, exploits the benefits from both distillation and pruning and supports both irregular and structured pruning.

Here, the ZWs 405 may be considered to be the unimportant weights that are removed after each training iteration. Initially, a random set of the weights 405, 406 in each matrix W are assigned to be zero (e.g., set as ZWs 405), and then a training process is performed. After each training iteration or epoch is performed, the weights 406 having the highest gradient magnitude among the set of weights 406 are retained (e.g., set to “1” or some other non-zero value) and the remaining weights 406 are removed (e.g., by setting those weights to be ZWs 405). The number of NZWs 406 to be retained after each training iteration/epoch may be predefined or configured, and/or may depend on the particular AI/ML task and/or the underlying ML model. A predetermined or configured number of training iterations/epochs are performed. The pruning mechanism 400 continues to prune weights 405 until the desired number of parameters is reached, where the desired number of parameters is indicated by the parameter budget 706.

1.4. Sparse Distillation Mechanism

Given a layer l with activation tensor A^{l}∈ [symbol] ^{H}^{ᵢₙ}^{^{l}}^{×W}^{ᵢₙ}^{^{l}}^{×C}^{ᵢₙ}^{^{l}}, the activation-based mapping function is defined as [symbol] =Σ_{c=1}^{C}^{ᵢₙ}^{^{l}}|A_{c}|^{p}, where p≥1. Here, Cᵢₙ^{l} represents the channels of spatial dimensions of Hᵢₙ^{l}×Wᵢₙ^{l}, and [symbol] is the flattened spatial attention map (see e.g., [Zagoruyko]). The teacher and student models are denoted Φ_{T} and Φ_{S}, respectively. Additionally, Ψ_{S}^{m} and Ψ_{T}^{m} represent the m^{th} pair of vectorized attention maps [symbol] of specific layers of Φ_{T} and Φ_{S}, respectively. The loss function for sparse distillation is then defined by equation (2).

$${ℒ}_{t o t a l} = {αℒ}_{S} ( y , {y}^{S} ) + ( 1 - α ) {ℒ}_{K L} ( σ ( \frac{{z}^{T}}{ρ} ) , σ ( \frac{{z}^{S}}{ρ} ) ) + \frac{β}{2} {\sum }_{m ∈ I} {‖ \frac{{Ψ}_{S}^{m}}{{‖ {Ψ}_{S}^{m} ‖}_{2}} - \frac{{Ψ}_{T}^{m}}{{‖ {Ψ}_{T}^{m} ‖}_{2}} ‖}_{p} \qquad ( 2 )$$

In equation (2), [symbol] ₜₒₜₐₗ is the total loss for sparse distillation; [symbol] _{S} is the cross entropy loss of the SA student Φ_{S} obtained by comparing the true logits y and the predicted logits y^{S}; [symbol] _{KL} represents the Kullback-Leibler divergence (KL) divergence loss (KD-loss) between the teacher Φ_{T} and student Φ_{S} transferring knowledge via logits; σ represents the softmax function with ρ being its temperature; z is an input to the softmax function (e.g., raw logits before applying the softmax function); and the last term,

$$\frac{β}{2} {\sum }_{m ∈ I} {‖ \frac{{Ψ}_{S}^{m}}{{‖ {Ψ}_{S}^{m} ‖}_{2}} - \frac{{Ψ}_{T}^{m}}{{‖ {Ψ}_{T}^{m} ‖}_{2}} ‖}_{2} ,$$

defines the activation-based attention transfer loss (AT-loss) between the two. Additionally, p refers to the norm type. In some implementations, the l₂-norm (e.g., p=2) of the normalized attention-maps is used to compute the loss (see e.g., [Zagoruyko]). In other implementations, the l₁-norm (e.g., p=1) of the normalized attention-maps can be used. Here, the norm is a function from a real or complex vector space to the nonnegative real numbers that behaves in certain ways like the distance from the origin: The l₂-norm (also referred to as the Euclidean norm) is a function that calculates the distance of a vector coordinate from an origin of the vector space, whereas the l₁-norm (also referred to as the taxicab norm or Manhattan norm) is calculated as the sum of the absolute vector values, and as such, is a calculation of the Manhattan distance from the origin of the vector space. Furthermore, the parameters α and β control the influence of each distillation method. For example, α is a hyperparameter of the linear combination of the cross entropy loss [symbol] _{S} and the KD-loss [symbol] K_{L}, and β is a hyperparameter that controls the relative importance of the cross entropy loss and the KD-loss. Additionally or alternatively, β controls the relative importance of the attention transfer loss. Additionally or alternatively, is a hyperparameter that decides the strength of the activation transfer (AT) loss.

To prune the student model Φ_{S} while simultaneously distilling knowledge from the teacher Φ_{T}, the Φ_{S}'s total trainable parameters is/are updated, and then a mask is used to forcibly set a fraction of these parameters to zero. Here, the “mask” for individual layers is a binary tensor used to make sure the trainable parameters have a fixed number of non-zeros based on a given pruning budget. The mask tensor can be both irregular or structured (regular) based on the selected/chosen type of model pruning technique. In one example, the mask tensor is an upper-triangular matrix, but may be some other suitable data structure. Based on aspects of sparse-learning, the distillation is started with initialized weights 405 and a random pruning mask that satisfies the non-zero parameter budget 706 corresponding to the target parameter density d for Φ_{S} (see e.g., [Kundu] and [Dettmers]). Based on the loss from equation (2), the layer's importance is evaluated by computing the normalized momentum contributed by its NZWs 406 during an epoch. This enables the determination of the layers that should have more NZWs 406 under the given parameter budget 706 and the pruning mask is updated accordingly. Concretely, the weights 405, 406 are regrown with the highest momentum magnitude after pruning a fixed percentage of the least-significant weights 405, 406 from each layer based on their magnitude (see e.g., [Dettmers]).

Details of the sparse distillation training are presented in Table 1.

TABLE 1
SPARSE DISTILLATION ALGORITHM

| | |
|---|---|
| 1 | Input: totalEpochs, momentum contribution μ^{l}, prune rate p (pₑ = 0), |
| | initial W, initial mask Π, target parameter density d, teacher |
| | model Φ_{T}, student model Φ_{S}. |
| 2 | Output: Sparse distilled Φ_{S}. |
| 3 | for l ← 0 to L do |
| 4 | / / Initialize weights W^{l}, mask Π^{l}, and apply mask Π^{l} |
| 5 | end |
| 6 | for e ← 0 to totalEpochs do |
| 7 | for t ← to totalBatches do |
| 8 | / / Evaluate student loss Lₜₒₜₐₗ and the gradient |
| 9 | / / Update weights and momentum contribution |
| 10 | for l ← to L do |
| 11 | / / Apply mask to weights |
| 12 | end |
| 13 | end |
| 14 | / / Evaluate total momentum |
| 15 | / / Get total weights to be pruned |
| 16 | / / Linearly decay prune rate pₑ |
| 17 | for l ← 0 to L do |
| 18 | / / Update layer momentum contribution μ^{l} |
| 19 | / / Prune fixed % of active weights from each layer |
| 20 | / / Regrow fraction of inactive weights based on μ^{l} |
| 21 | / / Update mask for next epoch |
| 22 | end |
| 23 | end |

In Table 1, p is a prune rate (or pruning rate), which is the rate at which the pruning and redistribution of weights across layers happens. Additionally, pₑ is a prune rate for a given epoch. The pruning rates may be in the form of a constant value, a percentage, or the like.

To reduce the effective model size and potentially speed up inference (see e.g., [Liu]), the framework 200 also supports column pruning, a form of structured pruning. Let the weight tensor of a convolutional layer l be denoted as W^{l}∈ [symbol] ^{C}^{ₒᵤₜ}^{^{l}}^{×C}^{ᵢₙ}^{^{l}}^{×k×k}, where Cₒᵤₜ^{l} and Cᵢₙ^{l} represent the number of filters and the number channel per filter, respectively, and k represent filter size. The tensor is converted to a 2D weight matrix with Cₒᵤₜ^{l} rows and Cᵢₙ^{l}×k×k columns. Next, this matrix is partitioned into and Cᵢₙ^{l}×k×k sub-matrices of Cₒᵤₜ^{l} rows and 1 column. To compute the importance of a column representing the (kₕ, k_{w})^{th} entry of the c^{th} channel of the filters, the Frobenius norm (F-norm) of a corresponding sub-matrix is determined, thus, effectively compute O_{c,k}_{ₕ}_{,k}_{_{w}}^{l}=∥W_{:,c,k}_{ₕ}_{,k}_{_{w}}∥_{F}². Based on the fraction of NZWs 406 that need to be regrown during an epoch e, pₑ, the number of columns that must be pruned from each layer Cₚₑ^{l} is computed, and the Cₚₑ^{l} columns with the lowest F-norms is/are pruned. Then, based on the layer importance measure (through momentum), the number of zero-F-norm columns rₑ^{l}≥0 that should be re-grown for each layer l is determined. Thus, the rₑ^{l} zero-F-norm columns with the highest F-norms of their momentum is/are regrown.

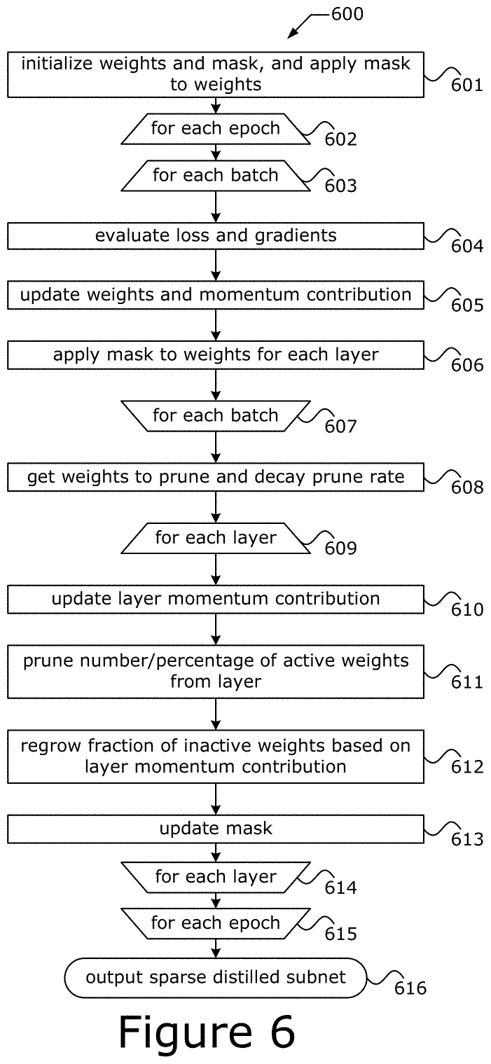

FIG. 6 depicts an example sparse distillation process 600 according to various embodiments. Process 600 may be performed by one or more compute nodes that operate the sparse distillation system 200. Process 600 begins at operation 601 where an initial weights W (e.g., weight vector or matrix) and an initial mask Π (e.g., mask vector or matrix) are initialized, and the mask Π is applied to the weights W. At open loop operation 602, the system 200 processes, in turn, operations 603-614 for each epoch e of a number of epochs (e.g., totalEpochs). Here, each epoch e is one training pass over an entire training dataset such that each training example has been seen once. Additionally, a pass may include one forward pass (e.g., traversing the model from the input layer to the output layer through any hidden layers between the input and output layers) and/or one backward pass (e.g., traversing the model in a reverse direction, from the output layer to the input layer).

At open loop operation 603, the system 200 processes, in turn, operations 604-606 for each batch of a number of batches (e.g., totalBatches). Here, a batch may be a set of training examples from the training dataset used in one iteration of model training. Each batch has a batch size, which is the number of training examples in one training pass. At operation 604, the system 200 evaluates the student loss [symbol] _{S} and the gradient for the present batch (see equation (2) supra). At operation 605, the system 200 updates the weights W and momentum contribution μ^{l}. At operation 606, the system 200 applies the mask Π to the weights for each layer l. At close loop operation 607, the system 200 returns to open loop operation 603 to process a next batch, if any. After all batches are processed, then the system 200 proceeds to operation 608. At to operation 608, the system 200 evaluates the total momentum μ, gets the total weights to be pruned, and decays the prune rate pₑ. Decaying the prune rate pₑ may be done as a linear decay in some implementations.

At open loop operation 609, the system 200 processes, in turn, operations 610-613 for each layer l of a number of layers L. At operation 610, the system 200 updates the layer's momentum contribution μ^{l}. At operation 611, the system 200 prunes a number or percentage of the active weights from the present layer l. At operation 612, the system 200 regrows a fraction of the inactive weights based on the layer's momentum contribution μ^{l}. At operation 613, the system 200 updates the mask Π for the next epoch e.

At close loop operation 614, the system 200 returns to open loop operation 609 to process a next layer l, if any. After all layers l are processed, then the system 200 proceeds to operation 615. At close loop operation 615, the system 200 returns to open loop operation 602 to process a next epoch e, if any. After all epochs e are processed, then the system 200 proceeds to operation 616 to output the sparse distilled subnet 103.

1.5. Sparse Distillation Use Cases

An example use case for the sparse distillation system 200 includes finding the best model or a set of models from a Neural Architecture Search (NAS) architecture 700 for a given task and dataset shown by FIG. 7.

FIG. 7 shows a NAS architecture 700 including the sparse distillation system 200 used in within or otherwise in conjunction with a NAS system 710s according to various embodiments. The NAS system 710s includes one or more compute nodes configured to operate a NAS application (app) 710a. The NAS app 710a includes an ML model NAS function 720, a subnet search function 725 (which may correspond to the sparse distillation system 200), and a subnet selection function 730. A user of the client device 701 operates a NAS app 710b to interact with the NAS app 710a to search for a suitable ML model and/or to optimize an existing ML model (e.g., supernet 705). The client device 701 may be any type of client or user device such as those discussed herein. To NAS app 710b may be, for example, a web browser, a desktop app, mobile app, a web app, and/or other like element that is configured to interact with the NAS app 710a using a suitable communication protocol (e.g., hypertext transfer protocol (HTTP) (or variants thereof), Message Queue Telemetry Transport (MQTT), Real Time Streaming Protocol (RTSP), and/or the like). The NAS app 710a may be a server-side app, edge computing app, cloud computing service, and/or other like element/entity that allows a user to provide an ML configuration (config.) 702 to the NAS app 710a using their NAS app 710b. The NAS app 710b may include a graphical user interface (GUI) including various graphical elements/objects that allow the user to add, update, and/or change the ML config. 702. Additionally, the NAS app 710a may include application programming interfaces (APIs) to access the other subsystems of the NAS app 710a, and/or sparse distillation system 200. The user uses the NAS app 710b to provide the ML config. 702 to the NAS app 710a to search for a suitable ML model and/or to optimize an existing ML model (e.g., supernet 705). Furthermore, the ML config. 702 may be an information object, file, electronic document, etc., in any suitable form or format such as, for example, a suitable mark-up language document (e.g., HyperText Markup Language (HTML), Extensible Markup Language (XML), AI Markup Language (AIML), JavaScript Object Notation (JSON), etc.), a columnar file format (e.g., Hierarchical Data Format (HDF) including HDF4, HDF5, etc.; Hadoop distributed file system (HDFS); Apache® Parquet, petastorm; etc.), tabular text-based format (e.g. comma separated values (csv), spreadsheet file formats (e.g., .xlsx, etc.)), model file formats (e.g., protocol buffer files (.pb file extension), Keras (.h5 file extension), python (.pkl file extension), PyTorch models (.pt file extension), predictive model markup language (.pmml file extension), the .mlmodel file format, etc.), and/or the like.

The ML config. 702 may include or indicate a supernet 705, a parameter budget 706, and/or dataset and task information (DTI) 707. The supernet 705 is an initial ML model to be searched for and/or optimized using the sparse distillation system 200. As mentioned previously, the parameter budget 706 is a file or other data structure that defines desired parameter aspects for the resulting subnet 201 after the training session is completed (e.g., a target parameter density d for the subnet 201 and/or a size of the subnet 201). The DTI 707 may include one or more a suitable dataset(s) for training and/or inference determination, supported libraries (e.g., tensor libraries, etc.), hardware platform configuration/specifications/technical details, parameter and/or hyperparameter types and/or values, and/or other like information/data. The DTI 707 in the ML config. 702 may be a reference to a remote storage or other resource(s) containing the dataset, which is then used by the NAS app 710a (or the NAS function 720) to obtain the dataset itself.

The hardware platform configuration/specifications/technical details indicate aspects of a hardware platform on which the user intends to deploy the sparse distilled subnet 103. In one example, the user can input various hardware (technical) details for an IoT device or autonomous sensor such as an image sensor for an object recognition model/subnet. In another example, the user can input or otherwise indicate a specific cloud computing platform/service (and optionally, available resources based on their cloud service subscription, account details, etc.) for an NLP model/subnet (e.g., for a chatbot or the like). In these examples, the hardware (technical) details may include information about the processor(s), memory devices, chipset, sensor types, etc. In some implementations, instead of requiring the user to provide a parameter budget 706, the NAS app 710b, NAS app 710a, or the NAS function 720 may derive or otherwise determine a suitable parameter budget 706 based on the hardware platform configuration/specifications/technical details (or aspects thereof).

In some implementations, the ML config. 702 may include or indicate one or more AI/ML tasks and an AI/ML domain rather than requiring the user to provide a specific supernet 705. Here, the one or more AI/ML tasks and an AI/ML domain would be used to perform NAS to discover suitable ML models for the user. The AI/ML tasks may describe a desired problem to be solved and the AI/ML domain may describe a desired goal to be achieved. Examples of ML tasks include clustering, classification, regression, anomaly detection, data cleaning, automated ML (autoML), association rules learning, reinforcement learning, structured prediction, feature engineering, feature learning, online learning, supervised learning, semi-supervised learning (SSL), unsupervised learning, machine learned ranking (MLR), grammar induction, and/or the like. ML domains include, reasoning and problem solving, knowledge representation and/or ontology, automated planning, natural language processing (NLP), perception (e.g., computer vision, speech recognition, etc.), autonomous motion and manipulation (e.g., localization, robotic movement/travel, autonomous driving, etc.), and social intelligence.

The ML config. 702 is provided to the NAS function 720, and also provided to the subnet selection function 730. In some implementations, only the parameter budget 706 is provided to the subnet selection function 730. The ML model NAS function 720 also obtains the DTI 707 specified by the ML config. 702 (e.g., using a suitable reference or obtained using some other mechanism).

The ML model NAS function 720 searches for, and discovers ML models (supernets) that fulfill the requirements in the ML config. 702, and provides the discovered models to the subnet search function 725. The ML models (supernets) searched for by the NAS function 720 may be in addition to the user-supplied supernet 705 and/or based on the AI/ML tasks and an AI/ML domain indicated by the ML config. 702. The ML model NAS function 720 may take into account the user-specified hardware platform (or some of the technical specifications of such a hardware platform) when performing the NAS. For example, various known or computed benchmarks of the specified hardware platform (or using some or all of the specified technical details) can be used as a one or more features used for the NAS.

The subnet search function 725 provides each candidate model (supernet) to the sparse distillation system 200. Each candidate model (supernet) may be input to the system 200 as supernet 205, and a corresponding sparse distilled subnet (e.g., subnet 103) is provided to the subnet selection function 730. The sparse distillation system 200 may distill each candidate model (supernet) into a sparse distilled subnet (e.g., subnet 103) that fits the parameter budget 706 (e.g., has a same or fewer parameters/weights than specified in the parameter budget 706) and/or fits at least some aspects of the user-specified hardware platform (or some of the technical specifications of such a hardware platform). For example, various known or computed benchmarks of the specified hardware platform (or using some or all of the specified technical details) can be used for KD, pruning, and/or SA.

From all the returned sparse distilled subnets, the subnet selection function 730 provides subnet result(s) 708 back to the client device/user. The subnet result(s) 708 includes or indicates one or more subnets configured to perform the desired AI/ML tasks specified by the user in the configuration 706 and/or based on the supernet 701. To provide the subnet result(s) 708, the subnet selection function 730 either selects, based on the parameter budget 706 and/or other ML config. 702 information, a most optimal sparse distilled subnet from among all sparse distilled subnets, or provides a search results list of some or all of the sparse distilled subnets to allow the user to select and download a preferred subnet from the search results list. For example, the subnet selection function 730 may provide search results in a same or similar manner as a search engine results page (SERP) provided by a search engine in response to a submitted a search query, where the SERP includes multiple links or other resources to obtain a corresponding subnet.

Conventional NAS systems would try out several possibilities that fit user-specified requirements (e.g., power, hardware platform, speed, accuracy, etc.) and then return the best candidates to the user. However, conventional NAS systems would exclude models based on their parameter count (e.g., memory consumption), power, and speed even if their accuracy or other performance metrics are superior to other discovered models. By contrast, the NAS architecture 700 includes the sparse distillation system 200, which distills and prunes the models into smaller subnets to fit the specified ML config. 702, and therefore, returns the more accurate models as viable candidates. In the naïve scenario (e.g., using a conventional NAS system), without the use of the sparse distillation system 200, the user would have to specify larger parameters in the ML config. 702 in order for the conventional NAS system to return the more accurate models as NAS results. Further, the models returned by the conventional NAS system would still have to be fine-tuned and/or tweaked via the time consuming optimization processes to make them suitable for the user's particular application/use case.

In some implementations, some or all of the elements of the NAS architecture 700 are operated by individual compute nodes. For example, the NAS architecture 700 may be part of a cloud computing service where the NAS system 710s comprises one or more application servers that operate the NAS app 710a in a distributed manner, and the sparse distillation system 200 is operated by one or more cloud compute nodes in a distributed manner. In another implementation, some or all of the elements of the NAS architecture 700 are software elements operated by a single compute node 710s such as an application server, an edge compute node, a content delivery network (CDN) node, and/or the like.

Additionally or alternatively to the NAS architecture 700, the sparse distillation system 200 may be useful for edge computing and in IoT frameworks. In this example use case, a sparse distilled version of a model (e.g., subnet 103) may operate on one or more IoT devices as a surrogate to a supernet 105, 205 from which the model was derived, and the supernet 105, 205 runs in an edge compute node or a cloud compute service, updating or improving upon the results over time. In this example, the surrogate subnets 103 may be part of a federated learning system. Additionally or alternatively, the surrogate subnets 103 may be used to provide instantaneous results to a user and/or when the user does not have connectivity and cannot obtain the services of the supernet 105, 205, the surrogate subnets 103 will continue to operate as normal thereby enhancing the user experience.

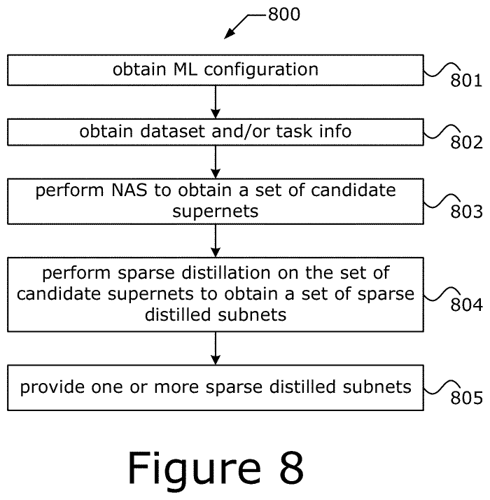

FIG. 8 depicts an example NAS process 800 according to various embodiments. Process 800 may be performed by the NAS system 710s. Process 800 begins at operation 801 where the NAS system 710s obtains an ML configuration 702 from a client device 701. At operation 802, the NAS system 710s obtains DTI 707 from the client device 701 or a remote resource. At operation 803, the NAS system 710s performs NAS to obtain a set of candidate supernets 105, 205. The NAS system 710s uses the ML configuration 702 and the DTI 707 to perform the NAS. At operation 804, the NAS system 710s performs sparse distillation on the set of candidate supernets 105, 205 to obtain a set of sparse distilled subnets 103. At operation 804, the NAS system 710s provides one or more sparse distilled subnets 103 of the set of sparse distilled subnets 103 to the client device 701. In some embodiments, the NAS system 710s provides the set of sparse distilled subnets 103 to the client device 701 in the form of search results list or the like. In some embodiments, the NAS system 710s may determine various performance metrics for each of the set of sparse distilled subnets 103, and provides some or all of these performance metrics with the search results. Alternatively, the NAS system 710s may provide an optimal sparse distilled subnet 103 of the set of sparse distilled subnets 103 based on one or more of the performance metrics.

### 2. Artificial Intelligence and Machine Learning Aspects

Machine learning (ML) involves programming computing systems to optimize a performance criterion using example (training) data and/or past experience. ML refers to the use and development of computer systems that are able to learn and adapt without following explicit instructions, by using algorithms and/or statistical models to analyze and draw inferences from patterns in data. ML involves using algorithms to perform specific task(s) without using explicit instructions to perform the specific task(s), but instead relying on learnt patterns and/or inferences. ML uses statistics to build mathematical model(s) (also referred to as “ML models” or simply “models”) in order to make predictions or decisions based on sample data (e.g., training data). The model is defined to have a set of parameters, and learning is the execution of a computer program to optimize the parameters of the model using the training data or past experience. The trained model may be a predictive model that makes predictions based on an input dataset, a descriptive model that gains knowledge from an input dataset, or both predictive and descriptive. Once the model is learned (trained), it can be used to make inferences (e.g., predictions).

ML algorithms perform a training process on a training dataset to estimate an underlying ML model. An ML algorithm is a computer program that learns from experience with respect to some task(s) and some performance measure(s)/metric(s), and an ML model is an object or data structure created after an ML algorithm is trained with training data. In other words, the term “ML model” or “model” may describe the output of an ML algorithm that is trained with training data. After training, an ML model may be used to make predictions on new datasets. Additionally, separately trained AI/ML models can be chained together in a AI/ML pipeline during inference or prediction generation. Although the term “ML algorithm” refers to different concepts than the term “ML model,” these terms may be used interchangeably for the purposes of the present disclosure. Any of the ML techniques discussed herein may be utilized, in whole or in part, and variants and/or combinations thereof, for any of the example embodiments discussed herein.

ML may require, among other things, obtaining and cleaning a dataset, performing feature selection, selecting an ML algorithm, dividing the dataset into training data and testing data, training a model (e.g., using the selected ML algorithm), testing the model, optimizing or tuning the model, and determining metrics for the model. Some of these tasks may be optional or omitted depending on the use case and/or the implementation used.

ML algorithms accept model parameters (or simply “parameters”) and/or hyperparameters that can be used to control certain properties of the training process and the resulting model. Model parameters are parameters, values, characteristics, configuration variables, and/or properties that are learnt during training. Model parameters are usually required by a model when making predictions, and their values define the skill of the model on a particular problem. Hyperparameters at least in some embodiments are characteristics, properties, and/or parameters for an ML process that cannot be learnt during a training process. Hyperparameter are usually set before training takes place, and may be used in processes to help estimate model parameters.

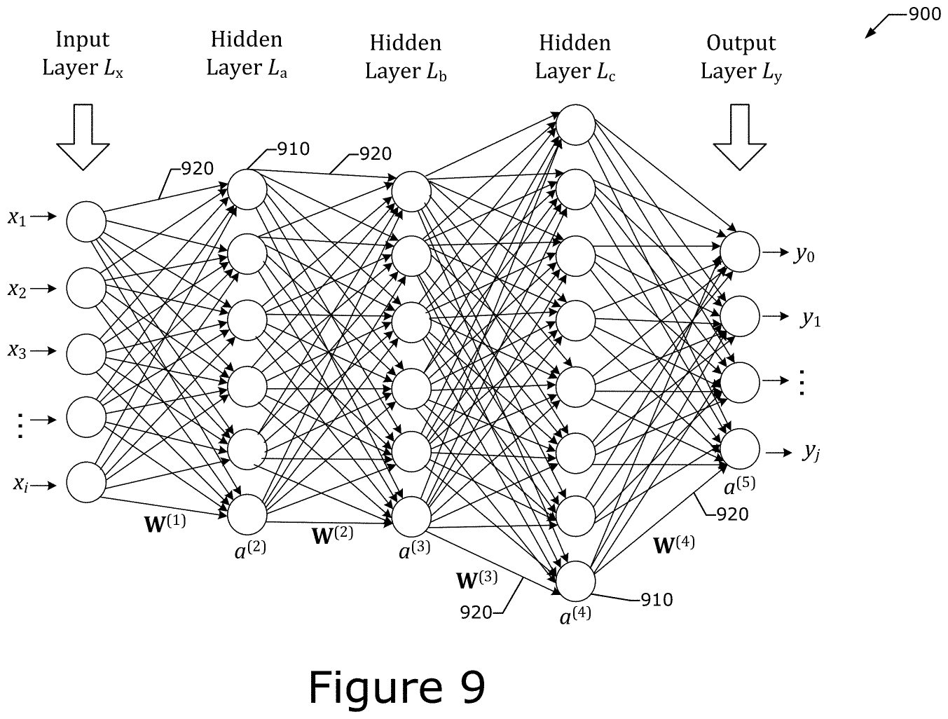

ML techniques generally fall into the following main types of learning problem categories: supervised learning, unsupervised learning, and reinforcement learning. Supervised learning involves building models from a set of data that contains both the inputs and the desired outputs. Unsupervised learning is an ML task that aims to learn a function to describe a hidden structure from unlabeled data. Unsupervised learning involves building models from a set of data that contains only inputs and no desired output labels. Reinforcement learning (RL) is a goal-oriented learning technique where an RL agent aims to optimize a long-term objective by interacting with an environment. Some implementations of AI and ML use data and neural networks (NNs) in a way that mimics the working of a biological brain. An example of such an implementation is shown by FIG. 9.

FIG. 9 illustrates an example NN 900, which may be suitable for use by one or more of the computing systems (or subsystems) of the various implementations discussed herein, implemented in part by a hardware accelerator, and/or the like. The NN 900 may be deep neural network (DNN) used as an artificial brain of a compute node or network of compute nodes to handle very large and complicated observation spaces. Additionally or alternatively, the NN 900 can be some other type of topology (or combination of topologies), such as any of those discussed herein. NNs are usually used for supervised learning, but can be used for unsupervised learning and/or RL.

The NN 900 may encompass a variety of ML techniques where a collection of connected artificial neurons 910 that (loosely) model neurons in a biological brain that transmit signals to other neurons/nodes 910. The neurons 910 may also be referred to as nodes 910, processing elements (PEs) 910, or the like. The connections 920 (or edges 920) between the nodes 910 are (loosely) modeled on synapses of a biological brain and convey the signals between nodes 910. Note that not all neurons 910 and edges 920 are labeled in FIG. 9 for the sake of clarity.

Each neuron 910 has one or more inputs and produces an output, which can be sent to one or more other neurons 910 (the inputs and outputs may be referred to as “signals”). Inputs to the neurons 910 of the input layer Lₓ can be feature values of a sample of external data (e.g., input variables xᵢ). The input variables xᵢ can be set as a vector containing relevant data (e.g., observations, ML features, etc.). The inputs to hidden units 910 of the hidden layers Lₐ, L_{b}, and L_{c} may be based on the outputs of other neurons 910. The outputs of the final output neurons 910 of the output layer L_{y} (e.g., output variables yⱼ) include predictions, inferences, and/or accomplish a desired/configured task. The output variables yⱼ may be in the form of determinations, inferences, predictions, and/or assessments. Additionally or alternatively, the output variables yⱼ can be set as a vector containing the relevant data (e.g., determinations, inferences, predictions, assessments, and/or the like).

In the context of ML, an “ML feature” (or simply “feature”) is an individual measureable property or characteristic of a phenomenon being observed. Features are usually represented using numbers/numerals (e.g., integers), strings, variables, ordinals, real-values, categories, and/or the like. Additionally or alternatively, ML features are individual variables, which may be independent variables, based on observable phenomenon that can be quantified and recorded. ML models use one or more features to make predictions or inferences. In some implementations, new features can be derived from old features.

Neurons 910 may have a threshold such that a signal is sent only if the aggregate signal crosses that threshold. A node 910 may include an activation function, which defines the output of that node 910 given an input or set of inputs. Additionally or alternatively, a node 910 may include a propagation function that computes the input to a neuron 910 from the outputs of its predecessor neurons 910 and their connections 920 as a weighted sum. A bias term can also be added to the result of the propagation function.

The NN 900 also includes connections 920, some of which provide the output of at least one neuron 910 as an input to at least another neuron 910. Each connection 920 may be assigned a weight that represents its relative importance. The weights may also be adjusted as learning proceeds. The weight increases or decreases the strength of the signal at a connection 920.

The neurons 910 can be aggregated or grouped into one or more layers L where different layers L may perform different transformations on their inputs. In FIG. 9, the NN 900 comprises an input layer Lₓ, one or more hidden layers Lₐ, L_{b}, and L_{c}, and an output layer L_{y} (where a, b, c, x, and y may be numbers),where each layer L comprises one or more neurons 910. Signals travel from the first layer (e.g., the input layer L₁), to the last layer (e.g., the output layer L_{y}), possibly after traversing the hidden layers Lₐ, L_{b}, and L_{c} multiple times. In FIG. 9, the input layer Lₐ receives data of input variables xᵢ (where i=1, . . . , p, where p is a number). Hidden layers Lₐ, L_{b}, and L_{c} processes the inputs xᵢ, and eventually, output layer L_{y} provides output variables yⱼ (where j=1, . . . , p′, where p′ is a number that is the same or different than p). In the example of FIG. 9, for simplicity of illustration, there are only three hidden layers Lₐ, L_{b}, and L_{c} in the ANN 900, however, the ANN 900 may include many more (or fewer) hidden layers Lₐ, L_{b}, and L_{c} than are shown.

### 3. Example Hardware and Software Configurations and Arrangements

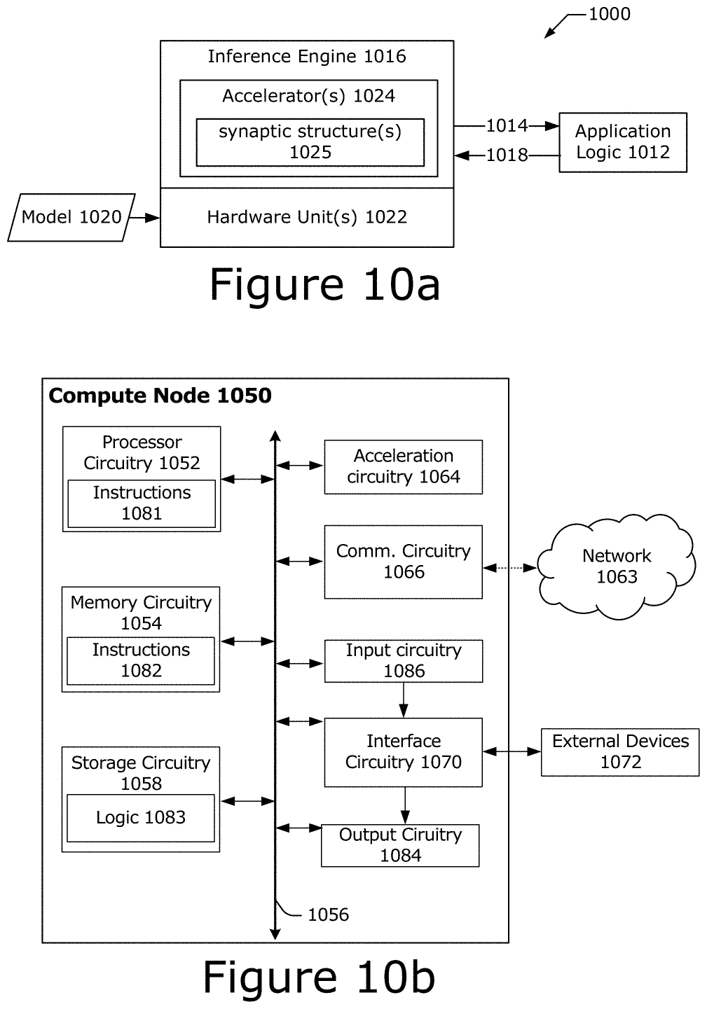

FIG. 10a is an example accelerator architecture 1000 for according to various embodiments. The accelerator architecture 1000 provides neural network (NN) functionality to application logic 1012, and as such, may be referred to as a NN accelerator architecture 1000, DNN accelerator architecture 1000, and/or the like.

The application logic 1012 may include application software and/or hardware components used to perform specification functions. The application logic 1012 forwards data 1014 to an inference engine 1016. The inference engine 1016 is a runtime element that delivers a unified application programming interface (API) that integrates a ANN (e.g., DNN(s) or the like) inference with the application logic 1012 to provide a result 1018 (or output) to the application logic 1012.

To provide the inference, the inference engine 1016 uses a model 1020 that controls how the DNN inference is made on the data 1014 to generate the result 1018. Specifically, the model 1020 includes a topology of layers of a NN. The topology includes an input layer that receives the data 1014, an output layer that outputs the result 1018, and one or more hidden layers between the input and output layers that provide processing between the data 14 and the result 1018. The topology may be stored in a suitable information object, such as an extensible markup language (XML), JavaScript Object Notation (JSON), and/or other suitable data structure, file, and/or the like. The model 1020 may also include weights and/or biases for results for any of the layers while processing the data 1014 in the inference using the DNN.

The inference engine 1016 may be implemented using and/or connected to hardware unit(s) 1022. The inference engine 1016 at least in some embodiments is an element that applies logical rules to a knowledge base to deduce new information. The knowledge base at least in some embodiments is any technology used to store complex structured and/or unstructured information used by a computing system (e.g., compute node 1050 of FIG. 10). The knowledge base may include storage devices, repositories, database management systems, and/or other like elements.

Furthermore, the inference engine 1016 includes one or more accelerators 1024 that provide hardware acceleration for the DNN inference using one or more hardware units 1022. The accelerator(s) 1024 are software and/or hardware element(s) specifically tailored/designed as hardware acceleration for AI/ML applications and/or AI/ML tasks. The one or more accelerators 1024 may include one or more processing element (PE) arrays and/or a multiply-and-accumulate (MAC) architecture in the form of a plurality of synaptic structures 1025. The accelerator(s) 1024 may correspond to the acceleration circuitry 1064 of FIG. 10 described infra.

The hardware unit(s) 1022 may include one or more processors and/or one or more programmable devices. As examples, the processors may include central processing units (CPUs), graphics processing units (GPUs), dedicated AI accelerator Application Specific Integrated Circuits (ASICs), vision processing units (VPUs), tensor processing units (TPUs) and/or Edge TPUs, Neural Compute Engine (NCE), Pixel Visual Core (PVC), photonic integrated circuit (PIC) or optical/photonic computing device, and/or the like. The programmable devices may include, for example, logic arrays, programmable logic devices (PLDs) such as complex PLDs (CPLDs), field-programmable gate arrays (FPGAs), programmable ASICs, programmable System-on-Chip (SoC), and the like. The processor(s) and/or programmable devices may correspond to processor circuitry 1052 and/or acceleration circuitry 1064 of FIG. 10.

FIG. 10b illustrates an example of components that may be present in a compute node 1050 for implementing the techniques (e.g., operations, processes, methods, and methodologies) described herein. FIG. 10b provides a view of the components of node 1050 when implemented as part of a computing device (e.g., as a mobile device, a base station, server computer, gateway, appliance, etc.). In some implementations, the compute node 1050 may be an application server, edge server, cloud compute node, or the like that operates some or all of the sparse distillation process 600 such as the NAS app 610 and/or the sparse distillation system 200 discussed previously. The compute node 1050 may include any combinations of the hardware or logical components referenced herein, and it may include or couple with any device usable with an edge communication network or a combination of such networks. The components may be implemented as ICs, portions thereof, discrete electronic devices, or other modules, instruction sets, programmable logic or algorithms, hardware, hardware accelerators, software, firmware, or a combination thereof adapted in the compute node 1050, or as components otherwise incorporated within a chassis of a larger system. For one embodiment, at least one processor 1052 may be packaged together with computational logic 1082 and configured to practice aspects of various example embodiments described herein to form a System in Package (SiP) or a System on Chip (SoC).

The node 1050 includes processor circuitry in the form of one or more processors 1052. The processor circuitry 1052 includes circuitry such as, but not limited to one or more processor cores and one or more of cache memory, low drop-out voltage regulators (LDOs), interrupt controllers, serial interfaces such as SPI, I²C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 1052 may include one or more hardware accelerators (e.g., same or similar to acceleration circuitry 1064), which may be microprocessors, programmable processing devices (e.g., FPGA, ASIC, etc.), or the like. The one or more accelerators may include, for example, computer vision and/or deep learning accelerators. In some implementations, the processor circuitry 1052 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein

The processor circuitry 1052 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low voltage processor, an embedded processor, or any other known processing elements, or any suitable combination thereof. The processors (or cores) 1052 may be coupled with or may include memory/storage and may be configured to execute instructions 1081 stored in the memory/storage to enable various applications or operating systems to run on the platform 1050. The processors (or cores) 1052 is configured to operate application software to provide a specific service to a user of the platform 1050. In some embodiments, the processor(s) 1052 may be a special-purpose processor(s)/controller(s) configured (or configurable) to operate according to the various embodiments herein.

As examples, the processor(s) 1052 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, Calif. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centrig™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 1052 may be a part of a system on a chip (SoC), System-in-Package (SiP), a multi-chip package (MCP), and/or the like, in which the processor(s) 1052 and other components are formed into a single integrated circuit, or a single package, such as the Edison™ or Galileo™ SoC boards from Intel® Corporation. Other examples of the processor(s) 1052 are mentioned elsewhere in the present disclosure.

The node 1050 may include or be coupled to acceleration circuitry 1064, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 1064 may comprise logic blocks or logic fabric and other interconnected resources that may be programmed (configured) to perform various functions, such as the procedures, methods, functions, etc. of the various embodiments discussed herein. In such implementations, the acceleration circuitry 1064 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 1052 and/or acceleration circuitry 1064 may include hardware elements specifically tailored for machine learning functionality, such as for operating performing ANN operations such as those discussed herein. In these implementations, the processor circuitry 1052 and/or acceleration circuitry 1064 may be, or may include, an AI engine chip that can run many different kinds of AI instruction sets once loaded with the appropriate weightings and training code. Additionally or alternatively, the processor circuitry 1052 and/or acceleration circuitry 1064 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPs™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 1052 and/or acceleration circuitry 1064 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin 970 provided by Huawei®, and/or the like. In some hardware-based implementations, individual subsystems of node 1050 may be operated by the respective AI accelerating co-processor(s), AI GPUs, TPUs, or hardware accelerators (e.g., FPGAs, ASICs, DSPs, SoCs, etc.), etc., that are configured with appropriate logic blocks, bit stream(s), etc. to perform their respective functions.

The node 1050 also includes system memory 1054. Any number of memory devices may be used to provide for a given amount of system memory. As examples, the memory 1054 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 1054 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 1054 is controlled by a memory controller. The individual memory devices may be of any number of different package types such as single die package (SDP), dual die package (DDP) or quad die package (Q17P). Any number of other memory implementations may be used, such as dual inline memory modules (DIMMs) of different varieties including but not limited to microDIMMs or MiniDIMMs.

Storage circuitry 1058 provides persistent storage of information such as data, applications, operating systems and so forth. In an example, the storage 1058 may be implemented via a solid-state disk drive (SSDD) and/or high-speed electrically erasable memory (commonly referred to as “flash memory”). Other devices that may be used for the storage 1058 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 1054 and/or storage circuitry 1058 may also incorporate three-dimensional (3D) cross-point (XPOINT) memories from Intel® and Micron®.

The memory circuitry 1054 and/or storage circuitry 1058 is/are configured to store computational logic 1083 in the form of software, firmware, microcode, or hardware-level instructions to implement the techniques described herein. The computational logic 1083 may be employed to store working copies and/or permanent copies of programming instructions, or data to create the programming instructions, for the operation of various components of system 1000 (e.g., drivers, libraries, application programming interfaces (APIs), etc.), an operating system of system 1000, one or more applications, and/or for carrying out the embodiments discussed herein. The computational logic 1083 may be stored or loaded into memory circuitry 1054 as instructions 1082, or data to create the instructions 1082, which are then accessed for execution by the processor circuitry 1052 to carry out the functions described herein. The processor circuitry 1052 and/or the acceleration circuitry 1064 accesses the memory circuitry 1054 and/or the storage circuitry 1058 over the IX 1056. The instructions 1082 direct the processor circuitry 1052 to perform a specific sequence or flow of actions, for example, as described with respect to flowchart(s) and block diagram(s) of operations and functionality depicted previously. The various elements may be implemented by assembler instructions supported by processor circuitry 1052 or high-level languages that may be compiled into instructions 1081, or data to create the instructions 1081, to be executed by the processor circuitry 1052. The permanent copy of the programming instructions may be placed into persistent storage devices of storage circuitry 1058 in the factory or in the field through, for example, a distribution medium (not shown), through a communication interface (e.g., from a distribution server (not shown)), over-the-air (OTA), or any combination thereof.

The IX 1056 couples the processor 1052 to communication circuitry 1066 for communications with other devices, such as a remote server (not shown) and the like. The communication circuitry 1066 is a hardware element, or collection of hardware elements, used to communicate over one or more networks 1063 and/or with other devices. In one example, communication circuitry 1066 is, or includes, transceiver circuitry configured to enable wireless communications using any number of frequencies and protocols such as, for example, the Institute of Electrical and Electronics Engineers (IEEE) 802.11 (and/or variants thereof), IEEE 802.15.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 1066 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others. In some embodiments, the communication circuitry 1066 may include or otherwise be coupled with the an accelerator 1024 including one or more synaptic devices/structures 1025, etc., as described previously.

The IX 1056 also couples the processor 1052 to interface circuitry 1070 that is used to connect node 1050 with one or more external devices 1072. The external devices 1072 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the node 1050, which are referred to as input circuitry 1086 and output circuitry 1084 in FIG. 10. The input circuitry 1086 and output circuitry 1084 include one or more user interfaces designed to enable user interaction with the platform 1050 and/or peripheral component interfaces designed to enable peripheral component interaction with the platform 1050. Input circuitry 1086 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 1084 may be included to show information or otherwise convey information, such as sensor readings, actuator position(s), or other like information. Data and/or graphics may be displayed on one or more user interface components of the output circuitry 1084. Output circuitry 1084 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 1050. The output circuitry 1084 may also include speakers and/or other audio emitting devices, printer(s), and/or the like. Additionally or alternatively, sensor(s) may be used as the input circuitry 1084 (e.g., an image capture device, motion capture device, or the like) and one or more actuators may be used as the output device circuitry 1084 (e.g., an actuator to provide haptic feedback or the like). Peripheral component interfaces may include, but are not limited to, a non-volatile memory port, a USB port, an audio jack, a power supply interface, etc. A display or console hardware, in the context of the present system, may be used to provide output and receive input of an edge computing system; to manage components or services of an edge computing system; identify a state of an edge computing component or service; or to conduct any other number of management or administration functions or service use cases.

The components of the node 1050 may communicate over the interconnect (IX) 1056. The IX 1056 may include any number of technologies, including Industry Standard Architecture (ISA) and/or extended ISA (EISA), FASTBUS, Low Pin Count (LPC) bus, Inter-Integrated Circuit (I²C), Serial Peripheral Interface (SPI), power management bus (PMBus), peripheral component IX (PCI), PCI express (PCIe), PCI extended (PCIx), Intel® QuickPath IX (QPI), Intel® Ultra Path IX (UPI), Intel® Accelerator Link, Compute Express Link (CXL), Coherent Accelerator Processor Interface (CAPI) and/or OpenCAPI, Intel® Omni-Path Architecture (OPA), RapidIO™, cache coherent interconnect for accelerators (CCIX), Gen-Z Consortium, HyperTransport and/or Lightning Data Transport (LDT), NVLink provided by NVIDIA®, InfiniBand (IB), Time-Trigger Protocol (TTP), FlexRay, PROFIBUS, Ethernet, Universal Serial Bus (USB), point-to-point interfaces, and/or any number of other IX technologies. The IX 1056 may be a proprietary bus, for example, used in a SoC based system.

The number, capability, and/or capacity of the elements of system 1000 may vary, depending on whether computing system 1000 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 1000 may comprise one or more components of a data center, a desktop computer, a workstation, a laptop, a smartphone, a tablet, a digital camera, a smart appliance, a smart home hub, a network appliance, and/or any other device/system that processes data.

### 4. Example Implementations

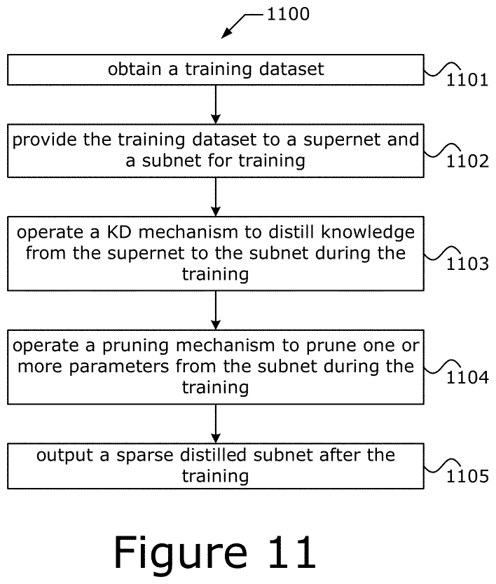

FIG. 11 depicts an example sparse distillation procedure 1100 according to various embodiments. The sparse distillation procedure 1100 is discussed as being performed by the compute node 1050, however, any other suitable device or system may perform process 1100 such as the accelerator(s) 1024. The sparse distillation procedure 1100 begins at operation 1101 where the compute node 1050 obtains a training dataset (e.g., including input data 220 of FIG. 2). At operation 1102, the compute node 1050 provides the training dataset to the supernet 205 and the subnet 201 for training. In some embodiments, the subnet 201 includes an SA mechanism 200. The SA mechanism 200 may replace a CNN, or the SA mechanism 200 may include a set of SA layers that replace convolutional layers in a CNN.

At operation 1103, the compute node 1050 operates the KD mechanism 202 to, during the training of the supernet 205 and the subnet 201, distill knowledge of the supernet 205 into the subnet 201. In embodiments, the training includes a single pass over the training dataset. At operation 1104, the compute node 1050 operates the pruning mechanism 400 to prune one or more parameters from the subnet 201 during the training (e.g., during the single pass over the training dataset). In embodiments, the knowledge distillation and the pruning takes place simultaneously. At operation 1105, the compute node 1050 outputs a sparse distilled subnet 103 after the training.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example A01 includes a method for sparse distillation of machine learning (ML) models, the method comprising: operating a knowledge distillation (KD) mechanism to distill knowledge of a supernet into a subnet during a single ML training epoch; and operating a pruning mechanism to prune one or more parameters from the subnet during the single ML training epoch to produce a sparse distilled subnet.

Example A02 includes the method of example A01 and/or some other example(s) herein, wherein the distillation of the knowledge and the pruning of the one or more parameters takes place simultaneously.

Example A03 includes the method of examples A01-A02 and/or some other example(s) herein, wherein the single ML training epoch includes a single pass over a training dataset.

Example A04 includes the method of examples A01-A03 and/or some other example(s) herein, wherein operating the KD mechanism comprising: training the supernet using a training dataset; and operating the supernet to extract the knowledge to be distilled into the subnet, and wherein distilling the knowledge comprises training the subnet using the training dataset used to train the supernet and using the extracted knowledge to guide the training of the subnet.

Example A05 includes the method of example A04 and/or some other example(s) herein, wherein the knowledge includes both logits and feature maps extracted from the supernet.

Example A06 includes the method of example A05 and/or some other example(s) herein, wherein the KD mechanism is configured to use an attention transfer distillation algorithm to transfer the knowledge from the supernet to the subnet.

Example A07.0 includes the method of examples A01-A06 and/or some other example(s) herein, further comprising: operating a self-attention (SA) mechanism.

Example A07.2 includes the method of example A07.0 and/or some other example(s) herein, wherein the SA mechanism is part of the subnet.

Example A07.4 includes the method of examples A07.0-A07.2 and/or some other example(s) herein, wherein operating the SA mechanism comprises: generating, based on input data, a queries matrix, a values matrix, and a keys matrix, wherein the queries matrix, the values matrix, and the keys matrix include the parameters to be pruned by the pruning mechanism; and providing the queries matrix, the values matrix, and the keys matrix to the pruning mechanism.

Example A08 includes the method of examples A07.0-A07.4 and/or some other example(s) herein, wherein operating the SA mechanism comprises: applying the input data to a parameterized learnable transformation (PLT) to generate the queries matrix, the values matrix, and the keys matrix.

Example A09 includes the method of examples A07-A08 and/or some other example(s) herein, wherein the SA mechanism includes the PLT.

Example A10 includes the method of examples A07-A09 and/or some other example(s) herein, wherein operating the SA mechanism comprises: performing an operation on the queries matrix and the keys matrix, wherein the operation is a matrix multiplication operation or a 1×1 convolution on the queries matrix and the keys matrix; applying a softmax function to an output of the operation; and generating an SA output based on a combination of the values matrix and an output of the softmax function.

Example A11 includes the method of examples A07-A10 and/or some other example(s) herein, wherein the SA mechanism replaces a convolutional neural network (CNN).

Example A12 includes the method of examples A01-A11 and/or some other example(s) herein, wherein the supernet is a convolutional neural network (CNN) comprising a set of convolutional layers and a set of layers that are not convolutional layers.

Example A13 includes the method of example A12 and/or some other example(s) herein, wherein the set of convolutional layers in the CNN are replaced with a set of SA layers.

Example A14 includes the method of examples A01-A13 and/or some other example(s) herein, wherein the method is performed by an apparatus.

Example A15 includes the method of example A14 and/or some other example(s) herein, wherein the apparatus is a client device, an application server, an edge computing server of an edge computing framework, or a cloud compute node of a cloud computing service.

Example A16 includes the method of examples A01-A15 and/or some other example(s) herein, wherein the supernet is neural network (NN) including one or more of a deep NN (DNN), feed forward NN (FFN), deep FNN (DFFN), convolutional NN (CNN), deep CNN (DCN), deconvolutional NN (DNN), deep belief NN, perception NN, graph NN, recurrent NN (RNN), Long Short Term Memory (LSTM) algorithm, gated recurrent unit (GRU), echo state network (ESN), spiking NN (SNN), deep stacking network (DSN), Markov chain, perception NN, generative adversarial network (GAN), transformer, self-attention (SA) mechanism, stochastic NN, Bayesian Network (BN), Bayesian belief network (BBN), Bayesian NN (BNN), Deep BNN (DBNN), Dynamic BN (DBN), probabilistic graphical model (PGM), Boltzmann machine, restricted Boltzmann machine (RBM), Hopfield network, convolutional deep belief network (CDBN), Linear Dynamical System (LDS), Switching LDS (SLDS), Optical NN (ONN), and/or an NN for reinforcement learning (RL) and/or deep RL (DRL).

Example A17 includes the method of example A16 and/or some other example(s) herein, wherein the subnet is a same type of NN as the supernet.

Example B01 includes a method of operating a Neural Architecture Search (NAS) application (app), the method comprising: obtaining an ML configuration from a client; obtaining a dataset and task information based on the ML configuration; performing, using information in the ML configuration, a NAS to obtain a set of candidate supernets; applying sparse distillation to each candidate supernet of the set of candidate supernets to obtain a set of sparse distilled subnets, wherein the sparse distillation comprises a KD mechanism configured to distill knowledge of each candidate supernet into corresponding sparse distilled subnets of the set of sparse distilled subnets during respective ML training epochs, and a pruning mechanism configured to prune one or more parameters from the corresponding sparse distilled subnets during the respective ML training epochs; and providing a message indicating the set of sparse distilled subnets to the client.

Example B02 includes the method of example B01 and/or some other example(s) herein, wherein the ML configuration includes a supernet to be sparse distilled into the corresponding sparse distilled subnet.

Example B03 includes the method of examples B01-B02 and/or some other example(s) herein, wherein the ML configuration includes an ML task to be performed.

Example B04 includes the method of examples B01-B03 and/or some other example(s) herein, wherein the ML configuration includes a desired number of parameters, and the corresponding sparse distilled subnets include the desired number of parameters or fewer than the desired number of parameters.

Example B05 includes the method of examples B01-B04 and/or some other example(s) herein, wherein the ML configuration indicates a desired hardware platform, and the corresponding sparse distilled subnets are sparse distilled to conform to the indicated hardware platform.

Example B06 includes the method of examples B01-B05 and/or some other example(s) herein, wherein the message includes the set of sparse distilled subnets in a form of a search results list.

Example B07 includes the method of examples B01-B06 and/or some other example(s) herein, wherein further comprising: identifying an optimal sparse distilled subnet from among the set of sparse distilled subnets, and wherein the message includes the optimal sparse distilled subnet.

Example B08 includes the method of examples B01-B07 and/or some other example(s) herein, wherein applying the sparse distillation comprises operating the sparse distillation system of any combination of examples A01-A14, C01-C10, and/or some other example(s) herein.

Example B09 includes the method of examples B01-B08 and/or some other example(s) herein, wherein the method is performed by a compute node.

Example B10 includes the method of example B09 and/or some other example(s) herein, wherein the compute node is an application server, an edge computing server of an edge computing framework, or a cloud compute node of a cloud computing service.

Example B11 includes the method of examples B01-B10 and/or some other example(s) herein, wherein the supernet is neural network (NN) including one or more of a deep NN (DNN), feed forward NN (FFN), deep FNN (DFFN), convolutional NN (CNN), deep CNN (DCN), deconvolutional NN (DNN), deep belief NN, perception NN, graph NN, recurrent NN (RNN), Long Short Term Memory (LSTM) algorithm, gated recurrent unit (GRU), echo state network (ESN), spiking NN (SNN), deep stacking network (DSN), Markov chain, perception NN, generative adversarial network (GAN), transformer, self-attention (SA) mechanism, stochastic NN, Bayesian Network (BN), Bayesian belief network (BBN), Bayesian NN (BNN), Deep BNN (DBNN), Dynamic BN (DBN), probabilistic graphical model (PGM), Boltzmann machine, restricted Boltzmann machine (RBM), Hopfield network, convolutional deep belief network (CDBN), Linear Dynamical System (LDS), Switching LDS (SLDS), Optical NN (ONN), and/or an NN for reinforcement learning (RL) and/or deep RL (DRL).

Example B12 includes the method of example B11 and/or some other example(s) herein, wherein the subnet is a same type of NN as the supernet.

Example C01 includes a method of operating a sparse distillation system, the method comprising: obtaining a training dataset for a first machine learning (ML) model; providing the training dataset to the first ML model and a second ML model, the second ML model being smaller than the first ML model; operating a knowledge distillation (KD) mechanism to, during training of the first and second ML models, distill knowledge of the first ML model into the second ML model during one pass over the training dataset; and operating a pruning mechanism to prune one or more parameters from the second ML model during the one pass over the training dataset.

Example C02 includes the method of example C01 and/or some other example(s) herein, wherein the second ML model that is smaller than the first ML model has fewer parameters than the first ML model, has fewer weights than the first ML model, takes up more storage space than the first ML model, includes more computations than the first ML model, and/or consumes more power than the first ML model.

Example C03 includes the method of examples C01-C02 and/or some other example(s) herein, wherein the distillation of the knowledge and the pruning of the one or more parameters takes place simultaneously.

Example C04 includes the method of examples C01-C03 and/or some other example(s) herein, wherein operating the KD mechanism comprises: training the first ML model using a training dataset; and operating the first ML model to extract the knowledge to be distilled into the second ML model, and wherein for distillation of the knowledge, operating the KD mechanism comprises training the second ML model using the training dataset used to train the first ML model and using the extracted knowledge to guide the training of the second ML model.

Example C05 includes the method of example C04 and/or some other example(s) herein, wherein operating the KD mechanism comprises: extracting logits and feature maps from the first ML model, and the knowledge includes both the extracted logits and the extracted feature maps.

Example C06 includes the method of examples C01-C05 and/or some other example(s) herein, wherein operating the KD mechanism comprises: operating an attention transfer distillation algorithm to transfer the knowledge from the first ML model to the second ML model such that the second ML model includes a spatial attention map that is similar to a spatial attention map of the first ML model.

Example C07 includes the method of examples C01-C06 and/or some other example(s) herein, further comprising: operating a self-attention (SA) mechanism.

Example C08 includes the method of example C07 and/or some other example(s) herein, wherein operating the SA mechanism comprises generating, based on the training dataset, a queries matrix, a values matrix, and a keys matrix, wherein the queries matrix, the values matrix, and the keys matrix include the parameters to be pruned by the pruning mechanism; and providing the queries matrix, the values matrix, and the keys matrix to the pruning mechanism.

Example C09 includes the method of examples C07-C08 and/or some other example(s) herein, wherein operating the SA mechanism comprises: applying parts of the training dataset to a parameterized learnable transformation (PLT) to generate the queries matrix, the values matrix, and the keys matrix; performing an operation on the queries matrix and the keys matrix, wherein the operation performed on the queries matrix and the keys matrix is a matrix multiplication operation or a 1×1 convolution on the queries matrix and the keys matrix; applying a softmax function to an output of the operation; and generating an SA output based on a combination of the values matrix and an output of the softmax function.

Example C10 includes the method of examples C07-009 and/or some other example(s) herein, wherein the SA mechanism replaces a CNN.

Example C11 includes the method of examples C07-C10 and/or some other example(s) herein, wherein the second ML model is a CNN comprising a set of convolutional layers and a set of layers that are not convolutional layers, wherein the set of convolutional layers in the CNN are replaced with a set of SA layers, and the set of SA layers form the SA mechanism.

Example C12 includes the method of examples C07-C11 and/or some other example(s) herein, wherein the first ML model is a CNN.

Example C13 includes the method of examples C01-C12 and/or some other example(s) herein, wherein the method is performed by a compute node.

Example C14 includes the method of example C13 and/or some other example(s) herein, wherein the compute node is a client device, an application server, an edge computing server of an edge computing framework, or a cloud compute node of a cloud computing service.

Example C15 includes the method of examples C01-C14 and/or some other example(s) herein, wherein the first ML model is neural network (NN) including one or more of a deep NN (DNN), feed forward NN (FFN), deep FNN (DFFN), convolutional NN (CNN), deep CNN (DCN), deconvolutional NN (DNN), deep belief NN, perception NN, graph NN, recurrent NN (RNN), Long Short Term Memory (LSTM) algorithm, gated recurrent unit (GRU), echo state network (ESN), spiking NN (SNN), deep stacking network (DSN), Markov chain, perception NN, generative adversarial network (GAN), transformer, self-attention (SA) mechanism, stochastic NN, Bayesian Network (BN), Bayesian belief network (BBN), Bayesian NN (BNN), Deep BNN (DBNN), Dynamic BN (DBN), probabilistic graphical model (PGM), Boltzmann machine, restricted Boltzmann machine (RBM), Hopfield network, convolutional deep belief network (CDBN), Linear Dynamical System (LDS), Switching LDS (SLDS), Optical NN (ONN), and/or an NN for reinforcement learning (RL) and/or deep RL (DRL).

Example C16 includes the method of example C15 and/or some other example(s) herein, wherein the second ML model is a same type of NN as the supernet.

Example D01 includes a joint optimization framework configured to produce parameter and compute efficient models in a single pass of training.

Example D02 includes the method of example D01 and/or some other example(s) herein, wherein the joint optimization framework includes the sparse distillation system of any combination of examples A01-A13, B01-B10, C01-C13, and/or some other example(s) herein.

Example Z01 includes one or more computer readable media comprising instructions, wherein execution of the instructions by processor circuitry is to cause the processor circuitry to perform the method of any one of examples A01-A17, B01-B12, C01-C16 and/or any other aspect discussed herein.

Example Z02 includes a computer program comprising the instructions of example Z01.

Example Z03 includes an Application Programming Interface defining functions, methods, variables, data structures, and/or protocols for the computer program of example Z02.

Example Z04 includes an apparatus comprising circuitry loaded with the instructions of example Z01.

Example Z05 includes an apparatus comprising circuitry operable to run the instructions of example Z01.

Example Z06 includes an integrated circuit comprising one or more of the processor circuitry of example Z01 and the one or more computer readable media of example Z01.

Example Z07 includes a computing system comprising the one or more computer readable media and the processor circuitry of example Z01.

Example Z08 includes an apparatus comprising means for executing the instructions of example Z01.

Example Z09 includes a signal generated as a result of executing the instructions of example Z01.

Example Z10 includes a data unit generated as a result of executing the instructions of example Z01.

Example Z11 includes the data unit of example Z10, the data unit is a datagram, network packet, data frame, data segment, a Protocol Data Unit (PDU), a Service Data Unit (SDU), a message, or a database object.

Example Z12 includes a signal encoded with the data unit of example Z10 or Z11.

Example Z13 includes an electromagnetic signal carrying the instructions of example Z01.

Example Z14 includes an apparatus comprising means for performing the method of any one of examples A01-A17, B01-B12, C01-C16 and/or any other aspect discussed herein.

### 5. Terminology

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” each of which may refer to one or more of the same or different embodiments. Furthermore, the terms “comprising,” “including,” “having,” and the like, as used with respect to the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some embodiments refers to (partial or in full) acts, tasks, operations, etc., related to bringing or the readying the bringing of something into existence either actively or passively (e.g., exposing a device identity or entity identity). Additionally or alternatively, the term “establish” or “establishment” at least in some embodiments refers to (partial or in full) acts, tasks, operations, etc., related to initiating, starting, or warming communication or initiating, starting, or warming a relationship between two entities or elements (e.g., establish a session, establish a session, etc.). Additionally or alternatively, the term “establish” or “establishment” at least in some embodiments refers to initiating something to a state of working readiness. The term “established” at least in some embodiments refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some embodiments refers to (partial or in full) acts, tasks, operations, etc., of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive the stream of packets (or the following parameters and templates or template values).

The term “element” at least in some embodiments refers to a unit that is indivisible at a given level of abstraction and has a clearly defined boundary, wherein an element may be any type of entity including, for example, one or more devices, systems, controllers, network elements, modules, etc., or combinations thereof.

The term “measurement” at least in some embodiments refers to the observation and/or quantification of attributes of an object, event, or phenomenon.

The term “accuracy” at least in some embodiments refers to the closeness of one or more measurements to a specific value. The term “precision” at least in some embodiments refers to the closeness of the two or more measurements to each other.

The term “signal” at least in some embodiments refers to an observable change in a quality and/or quantity. Additionally or alternatively, the term “signal” at least in some embodiments refers to a function that conveys information about of an object, event, or phenomenon. Additionally or alternatively, the term “signal” at least in some embodiments refers to any time varying voltage, current, or electromagnetic wave that may or may not carry information. The term “digital signal” at least in some embodiments refers to a signal that is constructed from a discrete set of waveforms of a physical quantity so as to represent a sequence of discrete values.

The term “circuitry” at least in some embodiments refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an ASIC, a FPGA, programmable logic controller (PLC), SoC, SiP, multi-chip package (MCP), DSP, etc., that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations including over different storage devices, and may exist, at least partially, merely as electronic signals on a system or network. The components or modules may be passive or active, including agents operable to perform desired functions.

The term “processor circuitry” at least in some embodiments refers to, is part of, or includes circuitry capable of sequentially and automatically carrying out a sequence of arithmetic or logical operations, or recording, storing, and/or transferring digital data. The term “processor circuitry” at least in some embodiments refers to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” at least in some embodiments refers to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The term “interface circuitry” at least in some embodiments refers to, is part of, or includes circuitry that enables the exchange of information between two or more components or devices. The term “interface circuitry” at least in some embodiments refers to one or more hardware interfaces, for example, buses, I/O interfaces, peripheral component interfaces, network interface cards, and/or the like.

The term “device” at least in some embodiments refers to a physical entity embedded inside, or attached to, another physical entity in its vicinity, with capabilities to convey digital information from or to that physical entity.

The term “entity” at least in some embodiments refers to a distinct component of an architecture or device, or information transferred as a payload.

The term “controller” at least in some embodiments refers to an element or entity that has the capability to affect a physical entity, such as by changing its state or causing the physical entity to move.

The term “compute node” or “compute device” at least in some embodiments refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment (UE), end consuming device, appliance, or the like.

The term “computer system” at least in some embodiments refers to any type interconnected electronic devices, computer devices, or components thereof. Additionally, the terms “computer system” and/or “system” at least in some embodiments refer to various components of a computer that are communicatively coupled with one another. Furthermore, the term “computer system” and/or “system” at least in some embodiments refer to multiple computer devices and/or multiple computing systems that are communicatively coupled with one another and configured to share computing and/or networking resources.

The term “architecture” at least in some embodiments refers to a computer architecture or a network architecture. A “computer architecture” is a physical and logical design or arrangement of software and/or hardware elements in a computing system or platform including technology standards for interacts therebetween. A “network architecture” is a physical and logical design or arrangement of software and/or hardware elements in a network including communication protocols, interfaces, and media transmission.

The term “appliance,” “computer appliance,” or the like, at least in some embodiments refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “user equipment” or “UE” at least in some embodiments refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface. Examples of UEs, client devices, etc., include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, Helmut-mounted display devices, augmented reality (AR) devices, virtual reality (VR) devices, mixed reality (MR) devices, and/or other like systems or devices.

The term “network element” at least in some embodiments refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like.

The term “application” at least in some embodiments refers to a computer program designed to carry out a specific task other than one relating to the operation of the computer itself. Additionally or alternatively, term “application” at least in some embodiments refers to a complete and deployable package, environment to achieve a certain function in an operational environment.

The term “algorithm” at least in some embodiments refers to an unambiguous specification of how to solve a problem or a class of problems by performing calculations, input/output operations, data processing, automated reasoning tasks, and/or the like.

The terms “instantiate,” “instantiation,” and the like at least in some embodiments refers to the creation of an instance. An “instance” also at least in some embodiments refers to a concrete occurrence of an object, which may occur, for example, during execution of program code.

The term “reference” at least in some embodiments refers to data useable to locate other data and may be implemented a variety of ways (e.g., a pointer, an index, a handle, a key, an identifier, a hyperlink, etc.).

The term “artificial intelligence” or “AI” at least in some embodiments refers to any intelligence demonstrated by machines, in contrast to the natural intelligence displayed by humans and other animals. Additionally or alternatively, the term “artificial intelligence” or “AI” at least in some embodiments refers to the study of “intelligent agents” and/or any device that perceives its environment and takes actions that maximize its chance of successfully achieving a goal.

The terms “artificial neural network”, “neural network”, or “NN” refer to an ML technique comprising a collection of connected artificial neurons or nodes that (loosely) model neurons in a biological brain that can transmit signals to other arterial neurons or nodes, where connections (or edges) between the artificial neurons or nodes are (loosely) modeled on synapses of a biological brain. The artificial neurons and edges typically have a weight that adjusts as learning proceeds. The weight increases or decreases the strength of the signal at a connection. Neurons may have a threshold such that a signal is sent only if the aggregate signal crosses that threshold. The artificial neurons can be aggregated or grouped into one or more layers where different layers may perform different transformations on their inputs. Signals travel from the first layer (the input layer), to the last layer (the output layer), possibly after traversing the layers multiple times. NNs are usually used for supervised learning, but can be used for unsupervised learning as well. Examples of NNs include deep NN (DNN), feed forward NN (FFN), deep FNN (DFFN), convolutional NN (CNN), deep CNN (DCN), deconvolutional NN (DNN), a deep belief NN, a perception NN, recurrent NN (RNN) (e.g., including Long Short Term Memory (LSTM) algorithm, gated recurrent unit (GRU), echo state network (ESN), etc.), spiking NN (SNN), deep stacking network (DSN), Markov chain, perception NN, generative adversarial network (GAN), transformers, self-attention mechanisms, stochastic NNs (e.g., Bayesian Network (BN), Bayesian belief network (BBN), a Bayesian NN (BNN), Deep BNN (DBNN), Dynamic BN (DBN), probabilistic graphical model (PGM), Boltzmann machine, restricted Boltzmann machine (RBM), Hopfield network or Hopfield NN, convolutional deep belief network (CDBN), etc.), Linear Dynamical System (LDS), Switching LDS (SLDS), Optical NNs (ONNs), an NN for reinforcement learning (RL) and/or deep RL (DRL), and/or the like.

The term “attention” in the context of machine learning and/or neural networks, at least in some embodiments refers to a technique that mimics cognitive attention, which enhances important parts of a dataset where the important parts of the dataset may be determined using training data by gradient descent. The term “dot-product attention” at least in some embodiments refers to an attention technique that uses the dot product between vectors to determine attention. The term “multi-head attention” at least in some embodiments refers to an attention technique that combines several different attention mechanisms to direct the overall attention of a network or subnetwork.

The term “attention model” or “attention mechanism” at least in some embodiments refers to input processing techniques for neural networks that allow the neural network to focus on specific aspects of a complex input, one at a time until the entire dataset is categorized. The goal is to break down complicated tasks into smaller areas of attention that are processed sequentially. Similar to how the human mind solves a new problem by dividing it into simpler tasks and solving them one by one. The term “attention network” at least in some embodiments refers to an artificial neural networks used for attention in machine learning.

The term “backpropagation” at least in some embodiments refers to a method used in NNs to calculate a gradient that is needed in the calculation of weights to be used in the NN; “backpropagation” is shorthand for “the backward propagation of errors.” Additionally or alternatively, the term “backpropagation” at least in some embodiments refers to a method of calculating the gradient of neural network parameters. Additionally or alternatively, the term “backpropagation” or “back pass” at least in some embodiments refers to a method of traversing a neural network in reverse order, from the output to the input layer through any intermediary hidden layers.

The term “Bayesian optimization” at least in some embodiments refers to a sequential design strategy for global optimization of black-box functions that does not assume any functional forms.

The term “classification” in the context of ML at least in some embodiments refers to an ML technique for determining the classes to which various data points belong. Here, the term “class” or “classes” at least in some embodiments refers to categories, and are sometimes called “targets” or “labels.” Classification is used when the outputs are restricted to a limited set of quantifiable properties. Classification algorithms may describe an individual (data) instance whose category is to be predicted using a feature vector. As an example, when the instance includes a collection (corpus) of text, each feature in a feature vector may be the frequency that specific words appear in the corpus of text. In ML classification, labels are assigned to instances, and models are trained to correctly predict the pre-assigned labels of from the training examples. ML algorithms for classification may be referred to as a “classifier.” Examples of classifiers include linear classifiers, k-nearest neighbor (kNN), decision trees, random forests, support vector machines (SVMs), Bayesian classifiers, convolutional neural networks (CNNs), among many others (note that some of these algorithms can be used for other ML tasks as well).

The term “convolution” at least in some embodiments refers to a convolutional operation or a convolutional layer of a CNN.

The term “context” or “contextual information” at least in some embodiments refers to any information about any entity that can be used to effectively reduce the amount of reasoning required (via filtering, aggregation, and inference) for decision making within the scope of a specific application. Additionally or alternatively, the term “context” or “contextual information” at least in some embodiments refers to a high-dimensional real-valued vector.

The term “convolutional filter” at least in some embodiments refers to a matrix having the same rank as an input matrix, but a smaller shape. In machine learning, a convolutional filter is mixed with an input matrix in order to train weights.

The term “convolutional layer” at least in some embodiments refers to a layer of a DNN in which a convolutional filter passes along an input matrix (e.g., a CNN). Additionally or alternatively, the term “convolutional layer” at least in some embodiments refers to a layer that includes a series of convolutional operations, each acting on a different slice of an input matrix.

The term “convolutional neural network” or “CNN” at least in some embodiments refers to a neural network including at least one convolutional layer. Additionally or alternatively, the term “convolutional neural network” or “CNN” at least in some embodiments refers to a DNN designed to process structured arrays of data such as images.

The term “convolutional operation” at least in some embodiments refers to a mathematical operation on two functions (e.g., ƒ and g) that produces a third function (ƒ*g) that expresses how the shape of one is modified by the other where the term “convolution” may refer to both the result function and to the process of computing it. Additionally or alternatively, term “convolutional” at least in some embodiments refers to the integral of the product of the two functions after one is reversed and shifted, where the integral is evaluated for all values of shift, producing the convolution function. Additionally or alternatively, term “convolutional” at least in some embodiments refers to a two-step mathematical operation element-wise multiplication of the convolutional filter and a slice of an input matrix (the slice of the input matrix has the same rank and size as the convolutional filter); and (2) summation of all the values in the resulting product matrix.

The term “covariance” at least in some embodiments refers to a measure of the joint variability of two random variables, wherein the covariance is positive if the greater values of one variable mainly correspond with the greater values of the other variable (and the same holds for the lesser values such that the variables tend to show similar behavior), and the covariance is negative when the greater values of one variable mainly correspond to the lesser values of the other.

The term “ensemble averaging” at least in some embodiments refers to the process of creating multiple models and combining them to produce a desired output, as opposed to creating just one model.

The term “ensemble learning” or “ensemble method” at least in some embodiments refers to using multiple learning algorithms to obtain better predictive performance than could be obtained from any of the constituent learning algorithms alone.

The term “event”, in probability theory, at least in some embodiments refers to a set of outcomes of an experiment (e.g., a subset of a sample space) to which a probability is assigned. Additionally or alternatively, the term “event” at least in some embodiments refers to a software message indicating that something has happened. Additionally or alternatively, the term “event” at least in some embodiments refers to an object in time, or an instantiation of a property in an object. Additionally or alternatively, the term “event” at least in some embodiments refers to a point in space at an instant in time (e.g., a location in space-time). Additionally or alternatively, the term “event” at least in some embodiments refers to a notable occurrence at a particular point in time.

The term “feature” at least in some embodiments refers to an individual measureable property, quantifiable property, or characteristic of a phenomenon being observed. Additionally or alternatively, the term “feature” at least in some embodiments refers to an input variable used in making predictions. At least in some embodiments, features may be represented using numbers/numerals (e.g., integers), strings, variables, ordinals, real-values, categories, and/or the like.

The term “feature engineering” at least in some embodiments refers to a process of determining which features might be useful in training an ML model, and then converting raw data into the determined features. Feature engineering is sometimes referred to as “feature extraction.”

The term “feature extraction” at least in some embodiments refers to a process of dimensionality reduction by which an initial set of raw data is reduced to more manageable groups for processing. Additionally or alternatively, the term “feature extraction” at least in some embodiments refers to retrieving intermediate feature representations calculated by an unsupervised model or a pre-trained model for use in another model as an input. Feature extraction is sometimes used as a synonym of “feature engineering.”

The term “feature map” at least in some embodiments refers to a function that takes feature vectors (or feature tensors) in one space and transforms them into feature vectors (or feature tensors) in another space. Additionally or alternatively, the term “feature map” at least in some embodiments refers to a function that maps a data vector (or tensor) to feature space. Additionally or alternatively, the term “feature map” at least in some embodiments refers to a function that applies the output of one filter applied to a previous layer. In some embodiments, the term “feature map” may also be referred to as an “activation map”.

The term “feature vector” at least in some embodiments, in the context of ML, refers to a set of features and/or a list of feature values representing an example passed into a model.

The term “forward propagation” or “forward pass” at least in some embodiments, in the context of ML, refers to the calculation and storage of intermediate variables (including outputs) for a neural network in order from the input layer to the output layer through any hidden layers between the input and output layers.

The term “hidden layer”, in the context of ML and NNs, at least in some embodiments refers to an internal layer of neurons in an ANN that is not dedicated to input or output. The term “hidden unit” refers to a neuron in a hidden layer in an ANN.

The term “hyperparameter” at least in some embodiments refers to characteristics, properties, and/or parameters for an ML process that cannot be learnt during a training process. Hyperparameter are usually set before training takes place, and may be used in processes to help estimate model parameters. Examples of hyperparameters include model size (e.g., in terms of memory space, bytes, number of layers, etc.); training data shuffling (e.g., whether to do so and by how much); number of evaluation instances, iterations, epochs (e.g., a number of iterations or passes over the training data), or episodes; number of passes over training data; regularization; learning rate (e.g., the speed at which the algorithm reaches (converges to) optimal weights); learning rate decay (or weight decay); momentum; number of hidden layers; size of individual hidden layers; weight initialization scheme; dropout and gradient clipping thresholds; the C value and sigma value for SVMs; the k in k-nearest neighbors; number of branches in a decision tree; number of clusters in a clustering algorithm; vector size; word vector size for NLP and NLU; and/or the like.

The term “inference engine” at least in some embodiments refers to a component of a computing system that applies logical rules to a knowledge base to deduce new information.

The terms “instance-based learning” or “memory-based learning” in the context of ML at least in some embodiments refers to a family of learning algorithms that, instead of performing explicit generalization, compares new problem instances with instances seen in training, which have been stored in memory. Examples of instance-based algorithms include k-nearest neighbor, and the like), decision tree Algorithms (e.g., Classification And Regression Tree (CART), Iterative Dichotomiser 3 (ID3), C4.5, chi-square automatic interaction detection (CHAID), etc.), Fuzzy Decision Tree (FDT), and the like), Support Vector Machines (SVM), Bayesian Algorithms (e.g., Bayesian network (BN), a dynamic BN (DBN), Naive Bayes, and the like), and ensemble algorithms (e.g., Extreme Gradient Boosting, voting ensemble, bootstrap aggregating (“bagging”), Random Forest and the like.

The term “intelligent agent” at least in some embodiments refers to an a software agent or other autonomous entity which acts, directing its activity towards achieving goals upon an environment using observation through sensors and consequent actuators (i.e. it is intelligent). Intelligent agents may also learn or use knowledge to achieve their goals.

The term “iteration” at least in some embodiments refers to the repetition of a process in order to generate a sequence of outcomes, wherein each repetition of the process is a single iteration, and the outcome of each iteration is the starting point of the next iteration. Additionally or alternatively, the term “iteration” at least in some embodiments refers to a single update of a model's weights during training.

The term “Kullback-Leibler divergence” at least in some embodiments refers to a measure of how one probability distribution is different from a reference probability distribution. The “Kullback-Leibler divergence” may be a useful distance measure for continuous distributions and is often useful when performing direct regression over the space of (discretely sampled) continuous output distributions. The term “Kullback-Leibler divergence” may also be referred to as “relative entropy”.

The term “knowledge base” at least in some embodiments refers to any technology used to store complex structured and/or unstructured information used by a computing system.

The term “knowledge distillation” in machine learning, at least in some embodiments refers to the process of transferring knowledge from a large model to a smaller one.

The term “logit” at least in some embodiments refers to a set of raw predictions (e.g., non-normalized predictions) that a classification model generates, which is ordinarily then passed to a normalization function such as a softmax function for models solving a multi-class classification problem. Additionally or alternatively, the term “logit” at least in some embodiments refers to a logarithm of a probability. Additionally or alternatively, the term “logit” at least in some embodiments refers to the output of a logit function. Additionally or alternatively, the term “logit” or “logit function” at least in some embodiments refers to a quantile function associated with a standard logistic distribution. Additionally or alternatively, the term “logit” at least in some embodiments refers to the inverse of a standard logistic function. Additionally or alternatively, the term “logit” at least in some embodiments refers to the element-wise inverse of the sigmoid function. Additionally or alternatively, the term “logit” or “logit function” at least in some embodiments refers to a function that represents probability values from 0 to 1, and negative infinity to infinity. Additionally or alternatively, the term “logit” or “logit function” at least in some embodiments refers to a function that takes a probability and produces a real number between negative and positive infinity.

The term “loss function” or “cost function” at least in some embodiments refers to an event or values of one or more variables onto a real number that represents some “cost” associated with the event. A value calculated by a loss function may be referred to as a “loss” or “error”. Additionally or alternatively, the term “loss function” or “cost function” at least in some embodiments refers to a function used to determine the error or loss between the output of an algorithm and a target value. Additionally or alternatively, the term “loss function” or “cost function” at least in some embodiments refers to a function are used in optimization problems with the goal of minimizing a loss or error.

The term “machine learning” or “ML” at least in some embodiments refers to the use of computer systems to optimize a performance criterion using example (training) data and/or past experience. ML involves using algorithms to perform specific task(s) without using explicit instructions to perform the specific task(s), and/or relying on patterns, predictions, and/or inferences. ML uses statistics to build mathematical model(s) (also referred to as “ML models” or simply “models”) in order to make predictions or decisions based on sample data (e.g., training data). The model is defined to have a set of parameters, and learning is the execution of a computer program to optimize the parameters of the model using the training data or past experience. The trained model may be a predictive model that makes predictions based on an input dataset, a descriptive model that gains knowledge from an input dataset, or both predictive and descriptive. Once the model is learned (trained), it can be used to make inferences (e.g., predictions). ML algorithms perform a training process on a training dataset to estimate an underlying ML model. An ML algorithm is a computer program that learns from experience with respect to some task(s) and some performance measure(s)/metric(s), and an ML model is an object or data structure created after an ML algorithm is trained with training data. In other words, the term “ML model” or “model” may describe the output of an ML algorithm that is trained with training data. After training, an ML model may be used to make predictions on new datasets. Additionally, separately trained AI/ML models can be chained together in a AI/ML pipeline during inference or prediction generation. Although the term “ML algorithm at least in some embodiments refers to different concepts than the term “ML model,” these terms may be used interchangeably for the purposes of the present disclosure. Furthermore, the term “AI/ML application” or the like at least in some embodiments refers to an application that contains some AI/ML models and application-level descriptions. ML techniques generally fall into the following main types of learning problem categories: supervised learning, unsupervised learning, and reinforcement learning.

The term “mathematical model” at least in some embodiments refer to a system of postulates, data, and inferences presented as a mathematical description of an entity or state of affairs including governing equations, assumptions, and constraints.

The terms “model parameter” and/or “parameter” in the context of ML, at least in some embodiments refer to values, characteristics, and/or properties that are learnt during training. Additionally or alternatively, “model parameter” and/or “parameter” in the context of ML, at least in some embodiments refer to a configuration variable that is internal to the model and whose value can be estimated from the given data. Model parameters are usually required by a model when making predictions, and their values define the skill of the model on a particular problem. Examples of such model parameters/parameters include weights (e.g., in an ANN); constraints; support vectors in a support vector machine (SVM); coefficients in a linear regression and/or logistic regression; word frequency, sentence length, noun or verb distribution per sentence, the number of specific character n-grams per word, lexical diversity, etc., for natural language processing (NLP) and/or natural language understanding (NLU); and/or the like.

The term “momentum” at least in some embodiments refers to an aggregate of gradients in gradient descent. Additionally or alternatively, the term “momentum” at least in some embodiments refers to a variant of the stochastic gradient descent algorithm where a current gradient is replaced with m (momentum), which is an aggregate of gradients.

The term “objective function” at least in some embodiments refers to a function to be maximized or minimized for a specific optimization problem. In some cases, an objective function is defined by its decision variables and an objective. The objective is the value, target, or goal to be optimized, such as maximizing profit or minimizing usage of a particular resource. The specific objective function chosen depends on the specific problem to be solved and the objectives to be optimized. Constraints may also be defined to restrict the values the decision variables can assume thereby influencing the objective value (output) that can be achieved. During an optimization process, an objective function's decision variables are often changed or manipulated within the bounds of the constraints to improve the objective function's values. In general, the difficulty in solving an objective function increases as the number of decision variables included in that objective function increases. The term “decision variable” refers to a variable that represents a decision to be made.

The term “optimization” at least in some embodiments refers to an act, process, or methodology of making something (e.g., a design, system, or decision) as fully perfect, functional, or effective as possible. Optimization usually includes mathematical procedures such as finding the maximum or minimum of a function. The term “optimal” at least in some embodiments refers to a most desirable or satisfactory end, outcome, or output. The term “optimum” at least in some embodiments refers to an amount or degree of something that is most favorable to some end. The term “optima” at least in some embodiments refers to a condition, degree, amount, or compromise that produces a best possible result. Additionally or alternatively, the term “optima” at least in some embodiments refers to a most favorable or advantageous outcome or result.

The term “probability” at least in some embodiments refers to a numerical description of how likely an event is to occur and/or how likely it is that a proposition is true. The term “probability distribution” at least in some embodiments refers to a mathematical function that gives the probabilities of occurrence of different possible outcomes for an experiment or event.

The term “quantile” at least in some embodiments refers to a cut point(s) dividing a range of a probability distribution into continuous intervals with equal probabilities, or dividing the observations in a sample in the same way. The term “quantile function” at least in some embodiments refers to a function that is associated with a probability distribution of a random variable, and the specifies the value of the random variable such that the probability of the variable being less than or equal to that value equals the given probability. The term “quantile function” may also be referred to as a percentile function, percent-point function, or inverse cumulative distribution function.

The terms “regression algorithm” and/or “regression analysis” in the context of ML at least in some embodiments refers to a set of statistical processes for estimating the relationships between a dependent variable (often referred to as the “outcome variable”) and one or more independent variables (often referred to as “predictors”, “covariates”, or “features”). Examples of regression algorithms/models include logistic regression, linear regression, gradient descent (GD), stochastic GD (SGD), and the like.

The term “reinforcement learning” or “RL” at least in some embodiments refers to a goal-oriented learning technique based on interaction with an environment. In RL, an agent aims to optimize a long-term objective by interacting with the environment based on a trial and error process. Examples of RL algorithms include Markov decision process, Markov chain, Q-learning, multi-armed bandit learning, temporal difference learning, and deep RL.

The term “sample space” in probability theory (also referred to as a “sample description space” or “possibility space”) of an experiment or random trial at least in some embodiments refers to a set of all possible outcomes or results of that experiment.

The term “self-attention” at least in some embodiments refers to an attention mechanism relating different positions of a single sequence in order to compute a representation of the sequence. Additionally or alternatively, the term “self-attention” at least in some embodiments refers to an attention mechanism applied to a single context instead of across multiple contexts wherein queries, keys, and values are extracted from the same context.

The term “softmax” or “softmax function” at least in some embodiments refers to a generalization of the logistic function to multiple dimensions; the “softmax function” is used in multinomial logistic regression and is often used as the last activation function of a neural network to normalize the output of a network to a probability distribution over predicted output classes.

The term “supervised learning” at least in some embodiments refers to an ML technique that aims to learn a function or generate an ML model that produces an output given a labeled data set. Supervised learning algorithms build models from a set of data that contains both the inputs and the desired outputs. For example, supervised learning involves learning a function or model that maps an input to an output based on example input-output pairs or some other form of labeled training data including a set of training examples. Each input-output pair includes an input object (e.g., a vector) and a desired output object or value (referred to as a “supervisory signal”). Supervised learning can be grouped into classification algorithms, regression algorithms, and instance-based algorithms.

The term “tensor” at least in some embodiments refers to an object or other data structure represented by an array of components that describe functions relevant to coordinates of a space. Additionally or alternatively, the term “tensor” at least in some embodiments refers to a generalization of vectors and matrices and/or may be understood to be a multidimensional array. Additionally or alternatively, the term “tensor” at least in some embodiments refers to an array of numbers arranged on a regular grid with a variable number of axes. At least in some embodiments, a tensor can be defined as a single point, a collection of isolated points, or a continuum of points in which elements of the tensor are functions of position, and the Tensor forms a “tensor field”. At least in some embodiments, a vector may be considered as a one dimensional (1D) or first order tensor, and a matrix may be considered as a two dimensional (2D) or second order tensor. Tensor notation may be the same or similar as matrix notation with a capital letter representing the tensor and lowercase letters with subscript integers representing scalar values within the tensor.

The term “unsupervised learning” at least in some embodiments refers to an ML technique that aims to learn a function to describe a hidden structure from unlabeled data. Unsupervised learning algorithms build models from a set of data that contains only inputs and no desired output labels. Unsupervised learning algorithms are used to find structure in the data, like grouping or clustering of data points. Examples of unsupervised learning are K-means clustering, principal component analysis (PCA), and topic modeling, among many others. The term “semi-supervised learning at least in some embodiments refers to ML algorithms that develop ML models from incomplete training data, where a portion of the sample input does not include labels.

The term “vector” at least in some embodiments refers to a tuple of one or more values called scalars, and a “feature vector” may be a vector that includes a tuple of one or more features.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations to provide greater bandwidth/throughput and to support edge services selections that can be made available to the edge systems being serviced. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1. An apparatus for sparse distillation of machine learning (ML) models, the apparatus comprising:
a knowledge distillation (KD) mechanism configured to distill knowledge of a supernet into a subnet during a single ML training epoch; and
a pruning mechanism configured to prune one or more parameters from the subnet during the single ML training epoch to produce a sparse distilled subnet.

2. The apparatus of claim 1, wherein the distillation of the knowledge and the pruning of the one or more parameters takes place simultaneously.

3. The apparatus of claim 1, wherein the single ML training epoch includes a single pass over a training dataset.

4. The apparatus of claim 1, wherein the KD mechanism is configured to:
train the supernet using a training dataset; and
operate the supernet to extract the knowledge to be distilled into the subnet, and
train the subnet using the training dataset and using the extracted knowledge to guide the training of the subnet.

5. The apparatus of claim 4, wherein the knowledge includes both logits and feature maps extracted from the supernet.

6. The apparatus of claim 5, wherein the KD mechanism is configured to use an attention transfer distillation algorithm to transfer the knowledge from the supernet to the subnet.

7. The apparatus of claim 1, wherein the first ML model is neural network (NN) including one or more of a deep NN (DNN), feed forward NN (FFN), deep FNN (DFFN), convolutional NN (CNN), deep CNN (DCN), deconvolutional NN (DNN), deep belief NN, perception NN, graph NN, recurrent NN (RNN), Long Short Term Memory (LSTM) algorithm, gated recurrent unit (GRU), echo state network (ESN), spiking NN (SNN), deep stacking network (DSN), Markov chain, perception NN, generative adversarial network (GAN), transformer, self-attention (SA) mechanism, stochastic NN, Bayesian Network (BN), Bayesian belief network (BBN), Bayesian NN (BNN), Deep BNN (DBNN), Dynamic BN (DBN), probabilistic graphical model (PGM), Boltzmann machine, restricted Boltzmann machine (RBM), Hopfield network, convolutional deep belief network (CDBN), Linear Dynamical System (LDS), Switching LDS (SLDS), Optical NN (ONN), and/or an NN for reinforcement learning (RL) and/or deep RL (DRL).

8. The apparatus of claim 1, further comprising a self-attention (SA) mechanism configured to:
generate, based on input data, a queries matrix, a values matrix, and a keys matrix, wherein the queries matrix, the values matrix, and the keys matrix include the parameters to be pruned by the pruning mechanism; and
provide the queries matrix, the values matrix, and the keys matrix to the pruning mechanism.

9. The apparatus of claim 8, wherein the SA mechanism is further configured to:
apply the input data to a parameterized learnable transformation (PLT) to generate the queries matrix, the values matrix, and the keys matrix.

10. The apparatus of claim 9, wherein the SA mechanism includes the PLT.

11. The apparatus of claim 8, wherein the SA mechanism is further configured to:
perform an operation on the queries matrix and the keys matrix, wherein the operation is a matrix multiplication operation or a 1×1 convolution on the queries matrix and the keys matrix;
apply a softmax function to an output of the operation; and
generate an SA output based on a combination of the values matrix and an output of the softmax function.

12. The apparatus of claim 8, wherein the SA mechanism replaces a convolutional neural network (CNN).

13. The apparatus of claim 1, wherein the supernet is a convolutional neural network (CNN) comprising a set of convolutional layers and a set of layers that are not convolutional layers.

14. The apparatus of claim 13, wherein the set of convolutional layers in the CNN are replaced with a set of SA layers.

15. The apparatus of claim 1, wherein the apparatus is a client device, an application server, an edge computing server of an edge computing framework, or a cloud compute node of a cloud computing service.

16. One or more non-transitory computer-readable media (NTCRM) for operating a sparse distillation system, wherein execution of the instructions by one or more processors of a compute node is to cause the compute node to:
obtain a training dataset for a first machine learning (ML) model;
provide the training dataset to the first ML model and a second ML model, the second ML model having fewer parameters than the first ML model;
operate a knowledge distillation (KD) mechanism to, during training of the first and second ML models, distill knowledge of the first ML model into the second ML model during one pass over the training dataset; and
operate a pruning mechanism to prune one or more parameters from the second ML model during the one pass over the training dataset.

17. The one or more NTCRM of claim 16, wherein the distillation of the knowledge and the pruning of the one or more parameters takes place simultaneously.

18. The one or more NTCRM of claim 16, wherein, to operate the KD mechanism, execution of the instructions is to further cause the compute node to:
train the first ML model using a training dataset; and
operate the first ML model to extract the knowledge to be distilled into the second ML model, and
train the second ML model using the training dataset and using the extracted knowledge to guide the training of the second ML model.

19. The one or more NTCRM of claim 18, wherein, to operate the KD mechanism, execution of the instructions is to further cause the compute node to:
extract logits and feature maps from the first ML model, wherein the knowledge includes both the extracted logits and the extracted feature maps.

20. The one or more NTCRM of claim 16, wherein, to operate the KD mechanism, execution of the instructions is to further cause the compute node to:
operate an attention transfer distillation algorithm to transfer the knowledge from the first ML model to the second ML model such that the second ML model includes a spatial attention map that is similar to a spatial attention map of the first ML model.

21. The one or more NTCRM of claim 16, wherein execution of the instructions is to further cause the compute node to operate a self-attention (SA) mechanism to:
generate, based on the training dataset, a queries matrix, a values matrix, and a keys matrix, wherein the queries matrix, the values matrix, and the keys matrix include the parameters to be pruned by the pruning mechanism; and
provide the queries matrix, the values matrix, and the keys matrix to the pruning mechanism.

22. The one or more NTCRM of claim 21, wherein, to operate the SA mechanism, execution of the instructions is to further cause the compute node to:
apply parts of the training dataset to a parameterized learnable transformation (PLT) to generate the queries matrix, the values matrix, and the keys matrix;
perform an operation on the queries matrix and the keys matrix, wherein the operation is a matrix multiplication operation or a 1×1 convolution on the queries matrix and the keys matrix;
apply a softmax function to an output of the operation; and
generate an SA output based on a combination of the values matrix and an output of the softmax function.

23. The one or more NTCRM of claim 21, wherein the SA mechanism replaces a convolutional neural network (CNN).

24. The one or more NTCRM of claim 21, wherein the first ML model is a convolutional neural network (CNN) comprising a set of convolutional layers and a set of layers that are not convolutional layers, wherein the set of convolutional layers in the CNN are replaced with a set of SA layers, and the set of SA layers form the SA mechanism.

25. The one or more NTCRM of claim 16, wherein the compute node is a client device, an application server, an edge computing server of an edge computing framework, or a cloud compute node of a cloud computing service.
